(19) United States
(12) Patent Application Publication
(10) Pub. No.: US 2003/0215094 A1
(43) Pub. Date: Nov. 20, 2003

(54) Coding process method and coding process device

(75) Inventors: Masashi Sato, Tokyo (JP); Hideki Yamamoto, Tokyo (JP)

Correspondence Address: VENABLE, BAETJER, HOWARD AND CIVILETTI, LLP, P.O. BOX 34385, WASHINGTON, DC, 20043-9998, US

(73) Assignee: Oki Electric Industry Co., Ltd., Tokyo (JP)

(21) Appl. No.: 10/437,297

(22) Filed: May 14, 2003

(30) Foreign Application Priority Data
May 15, 2002 (JP) JP2002-140656

(51) Int. Cl. H04L 9/00

(52) U.S. Cl. 380/268

(57) ABSTRACT

In this embodiment, a number is allocated to each packet, so that the ordinal number of a byte to be used with respect to the start of a pseudo random number bit string can be determined. The pseudo random number bit string generated by this method is repeatedly reused to some extend to make an operation speed high. A number to be allocated is adjusted, so that a repeating rate can be changed. In this manner, as in OFB, a pseudo random number bit string used in decoding can be completely prevented from being repeated, and security and a speed can be balanced as needed. In addition, since a specific position to be used of the pseudo random number bit string is managed by a number allocated to each packet, a packet loss does not affect decoding.

### BACKGROUND OF THE INVENTION

1. Field of the Invention

The present invention relates to a coding process method and a coding process apparatus and, more particularly, to a technique which modifies an OFB (Output FeedBack) mode serving as one of process modes for block coding to stably code and decode a packet at a high speed.

2. Description of the Related Art

A block coding method is a coding process method which forms a pseudo random number bit string having a predetermined length from an initial vector and a key. As a method of forming a pseudo random number bit string, a coding algorithm such as Rijndael or DES is known. For example, when Rijndael is used, 16, 24, or 32 bytes can be selected as a pseudo random number bit string length. Since a block having a predetermined length is continuously formed for an input, the pseudo random number bit string length is called a “block code”. However, even in Rijndael which is a mainstream at the present, only blocks having 16, 24, and 32 bytes can be formed. For this reason, long data cannot be coded. In order to make the length of processible data flexible, some process modes are known. One of these process modes, OFB is known.

In OFB, an initial vector is substituted for a coding function to generate a pseudo random number bit string. The generated pseudo random number bit string is also substituted for a coding function to generate a new pseudo random number bit string. The new generated pseudo random number bit string is connected to a previous pseudo random number bit string to generate another long pseudo random number bit string. This operation is repeated to generate a pseudo random number bit string having a sufficiently long pseudo random number bit string. Exclusive OR (XOR: exclusive OR) between the pseudo random number bit string and a message is used as a code, and XOR between the code and a random number is calculated to perform decoding.

In recent years, with the popularization of broadband networks, digital contents such as movie delivery have been made satisfactory. Since the digital contents are not deteriorated even though the digital contents are copied, the digital contents may be illegally copied and delivered. In contrast to this, security for protecting the profit of a right holder of contents is required to be made satisfactory. In consideration of delivery on a network, a common key coding process method is one of cornerstones of security. With respect to coding functions themselves, as represented by Advanced Encryption Standard (common name: AES), many studies are made, and an abundance of research paper is known.

Not only the security but also practicability must be considered. The reasons why Rijndael is selected as AES include easiness on packaging and a high-speed process. Although a coding process method is to protect digital contents, packaging and processes for coding and decoding are difficult. As a result, it does not means because the coding process method is not used.

With the popularization of broadband contents, a coding system has requested the followings.

(1) The system is not overloaded on processes. In comparison with 2- or 3-year-old circumstances, a large-volume file, e.g., 10 Mbytes or more is downloaded or streamed on a daily basis. As a result, the large-volume file must be processed on both a server side and a client side. Accordingly, a coding system is required to be safe and executed at a sufficiently high speed.

(2) The system can cope with real-time properties of streaming. In a streaming scheme, a user need not wait until all multimedia digital contents files are downloaded on a player device, and the player device reproduces video data and audio data delivered as a stream from a delivery server while receiving the video data and the audio data. At this time, in order to maintain the real-time properties, a frame rate is regulated depending on the condition of a network and the performance of the server and a client. However, this means that all coded packets cannot be received and decoded. Therefore, a device which can easily cope with a packet loss is required.

However, a general OFB is poor at a packet loss. In case of data transmission, when data cannot be transmitted once, the data is divided and transmitted. The divided unit is called a packet. In order to correctly assemble the divided and transmitted data on a reception side, numbers representing the transmission order of the data are required. It is called a packet loss that the packets cannot be received in this order of the numbers or that a packet of a certain number cannot be received. A measure against the packet loss will be considered. For example, as in a case in which a still image is received by TCP (Transmission Control Protocol), although a long time may be taken to some extent, the completeness of data is regarded. In this case, when a packet loss occurs, the reception side may request the transmission side to retransmit a packet. Of course, it requires a long period of time.

On the other hand, as in a case in which movie data is received by streaming, when not only the completeness of the data but also real-time properties are required, how to cope with a packet loss will be considered. In this case, retransmission cannot be requested each time a packet is lost. This is because, the data must be reproduced on real time depending on a time stamp. An algorithm must be designed on the assumption that a packet loss occurs.

As one of restoring methods, a method which gives information related to the length of a lost packet to a decoding side and extends a bit string by the length of the lost packet is known. For this purpose, the information related to the length of the lost packet is required. When the length of each packet is constant, the total length can be obtained by calculating (the number of lost packets)×(the length of each packet). However, when the lengths of packets are not constant, the sum of the lengths of lost packets must be calculated. For this purpose, the lengths of the lost packets are requested to the transmission side, or a list of the lengths of the packets must be held or calculated in advance on the reception side. In any case, a measure against a packet loss is not sufficient, and the process requires a long period of time.

As another restoring method, a method in which a coding side sends an initial vector and a key to a decoding side as needed. For example, Association of Radio Industries and Business (common name: ARIB) uses this method as the specification of digital broadcasting. For example, for a 30-minute program, a key and an initial vector corresponding to a packet are transmitted and received every minute. In this case, when once a packet loss occurs, another initial vector is sent 1 minute after. For this reason, at the latest, a packet loss can be restored one minute after. However, in this period of time, the contents cannot be audiovisually received. If the number of times of transmission/reception of keys and initial vectors is increased, public key codes must be calculated each time a key and an initial vector are transmitted or received. The calculation of the public key code requires a period of time which is 1000 times the calculation of a common key code, and a load on a process cannot be neglected.

In case of digital broadcasting, a device on a reception side is ruled as a communication infrastructure, processing capabilities are expected on both a coding side and a decoding side. However, in streaming, a general-purpose personal computer which receives and processes data. Although communication infrastructures have been developed, the communication infrastructures are still unstable because a communication speed varies from place to place depending on time. These infrastructures are required to have a certain level of processing capability. A coding process method which can process data even in a general two- or three-year-old personal computer is required. Since users who can watch and hear contents are limited to specific users to achieve excessive security, the coding process method cannot be actually applied. A method which has a sufficient speed and which can cope with unstable communication conditions is necessary.

### SUMMARY OF THE INVENTION

The present invention has been made in consideration of the above problems included in a conventional coding process method, and has as its object to provide a novel improved coding process method and device which can increase coding and decoding speeds and which can easily continue to code even though a packet loss occurs in communication. The present invention is especially effective in an environment in which real-time properties and decoding on the assumption that a packet loss occurs are required as in real-time delivery of a movie by streaming. The present invention can be executed by a general-purpose microprocessor or the like.

In order to solve the above problem, according to the first aspect of the present invention, there is provided a coding process method which performs a coding process of stream data transmitted in units of packets. The coding process method of the present invention includes: the first step of predicting the maximum length of a bit string (in-packet bit string) included in each of the packets to generate a pseudo random number bit string having a length larger than the predicted maximum length of the in-packet bit string; and the second step of performing a coding process of the in-packet bit string by using the pseudo random number bit string.

In the coding process method according to the present invention, the maximum length of the bit string in each packet is predicted in advance, a pseudo random number bit string having a length larger than the predicted maximum length of the in-packet bit string, and the pseudo random number bit string is used in a coding process. In this manner, when once the pseudo random number bit string is generated, the same pseudo random number bit string can be repeatedly used in a coding process of bit strings in all the packets. In this manner, in comparison with a conventional technique which generates a pseudo random number bit string for each packet, a processing speed can be considerably increased.

In order to solve the above problem, according to the second aspect of the present invention, there is provided a coding process device which performs a coding process of stream data transmitted in units of packets. The coding process device according to the present invention includes: a pseudo random number bit string generation unit for predicting the maximum length of a bit string (in-packet bit string) included in each of the packets to generate a pseudo random number bit string having a length larger than the predicted maximum length of the in-packet bit string; and a coding process unit for performing a coding process of the in-packet bit string by using the pseudo random number bit string.

In the coding process device according to the present invention, the maximum length of a bit string in each packet is predicted, a pseudo random number bit string having a length larger than the predicted maximum length of the in-packet bit string is generated, and the pseudo random number bit string can be used in a coding process. In this manner, when once the pseudo random number bit string is generated, the same pseudo random number bit string can be repeatedly used in a coding process of bit strings in all the packets. In this manner, in comparison with a conventional technique which generates a pseudo random number bit string for each packet, a processing speed can be considerably increased.

### BRIEF DESCRIPTION OF THE DRAWING

FIG. 1 is a diagram for explaining the configuration of the first embodiment.

FIGS. 2A and 2B are diagrams for explaining a folding operation.

FIG. 3 is a flow chart for explaining a folding unit.

FIG. 4 is a flow chart for explaining an operation of the first embodiment.

FIGS. 5A and 5B are diagrams for explaining positional relationships between bit strings and packets.

FIG. 6 is a diagram for explaining the configuration of the second embodiment.

FIG. 7 is a diagram for explaining an XOR start position determination means.

FIG. 8 is a diagram for explaining a folding operation of a pseudo random number bit string on packaging.

FIG. 9 is a diagram for explaining an operation of the second embodiment.

FIGS. 10A and 10B are diagrams for explaining a positional relationship between a packet and a bit string.

FIG. 11 is a diagram for explaining a configuration of the third embodiment.

FIG. 12 is a diagram for explaining division of a pseudo random number bit string into sections.

FIGS. 13A and 13B are diagrams for explaining a case of updating a pseudo random number bit string.

FIG. 14 is a diagram for explaining an operation of the third embodiment.

FIG. 15 is a diagram for explaining a bit string updating operation.

FIG. 16 is a diagram for explaining of extension of conditions with respect to a packet number.

FIG. 17 is a diagram for explaining (condition A′) on a bit string.

FIGS. 18A and 18B are diagrams for explaining an example of updating in a pseudo random number bit string on packaging under (condition A′).

FIG. 19 is a diagram for explaining an operation of the fourth embodiment.

FIG. 20 is a diagram for explaining the configuration of the fifth embodiment.

FIGS. 21A and 21B are diagrams for explaining the configuration of a seed extraction unit.

FIG. 22 is a diagram for explaining a jump reproducing unit.

FIG. 23 is a diagram showing a stepping-stone decoding unit.

FIG. 24 is a diagram explaining a flow of transmission/reception in jump reproduction.

FIG. 25 is a diagram explaining a flow of transmission/reception in stepping-stone reproduction.

FIG. 26 is a diagram for explaining the configuration of the sixth embodiment.

FIGS. 27A and 27B are diagrams for explaining drawbacks in extension of a bit string.

FIG. 28 is a diagram for explaining an extending method of a bit string on packaging.

FIG. 29 is a diagram for explaining an operation of the sixth embodiment.

FIG. 30 is a diagram for explaining results of speed tests.

### DETAILED DESCRIPTION OF THE PREFERRED EMBODIMENTS

Preferred embodiments of a coding process method and a coding process device according to the present invention will be described below with reference to the accompanying drawings. The same reference numerals as in the specification and the drawings denote constituent elements which substantially have the same function configurations, and a repetitive explanation will be omitted.

Terms will be defined for explaining the following embodiments.

streamlength: the length of a pseudo random number bit string on packaging. A byte is used as a unit. A pseudo random number bit string “on packaging” means a pseudo random number bit string having a limited length and actually used in packet coding process. A “theoretical” pseudo random number bit string (to be described later) means a pseudo random number bit string, having an infinite length, for corresponding to stream data having an actually infinite length.

maxplen: value which is predicted as the maximum value of the length of a packet to be coded/decoded. A byte is used as a unit. On packaging, the maximum value may be slightly larger than the accurate maximum value depending on a memory on a transmission/reception side. This embodiment will be explained on the assumption that streamlength is set to be n times (n is a natural number) maxplen, i.e., n=4 is satisfied for descriptive convenience. First, maxplen is input when a pseudo random number bit string is generated.

seq: packet numbers allocated to packets. Packets are numbered from zero in the order of transmission.

position: a “start position” at which XOR is performed together with a packet in a pseudo random number bit string on packaging. A byte is used as a unit. The start and end of a pseudo random number bit string on packaging are discriminated as a “start position” and an “end position”, respectively.

(First Embodiment)

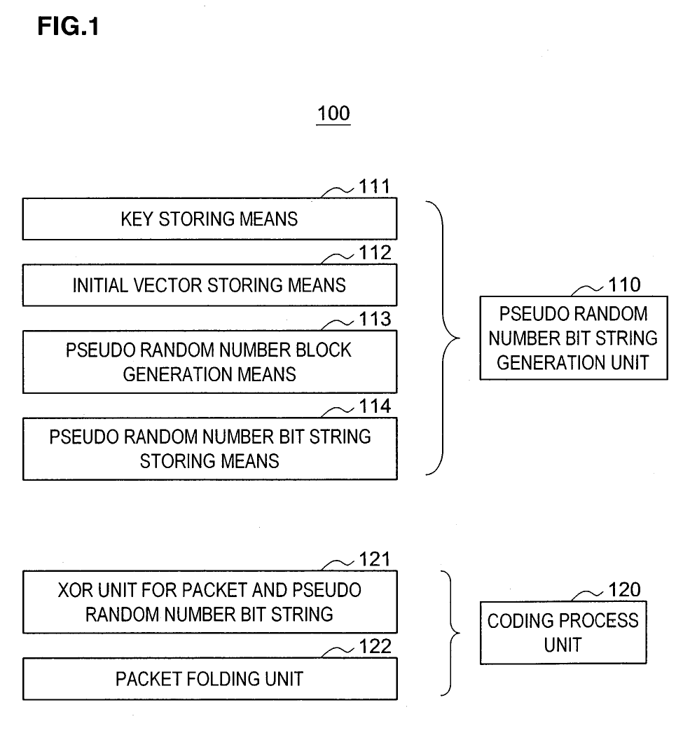

FIG. 1 is a diagram for explaining the configuration of a coding process device 100 according to the present invention. The coding process device 100, as shown in FIG. 1, includes two constituent elements, i.e., a pseudo random number bit string generation unit 110 and a coding process unit 120.

(Pseudo Random Number Bit String Generation Unit 110)

The pseudo random number bit string generation unit 110 comprises a key storing means 111, an initial vector storing means 112, a pseudo random number bit string generation means 113, and a pseudo random number bit string storing means 114.

The key storing means 111 is a constituent element for setting a key. The initial vector storing means 112 is a constituent element for setting an initial vector. The pseudo random number bit string generation means 113 is a constituent element which receives a pseudo random number block having a predetermined length to generate a new pseudo random number block by a selected coding function. The pseudo random number bit string storing means 114 is a constituent element which connects generated blocks to make a pseudo random number bit string having a length of maxplen×n (n is a natural number)=streamlength. In the following description, for descriptive convenience, n=4 is satisfied. However, this value is not essentially related to the present invention, and n is arbitrarily set.

(Coding Process Unit 120)

The coding process unit 120 comprises an XOR unit (to be simply referred to as an XOR unit hereinafter) 121 for performing an exclusive OR operation (XOR) between a packet and a pseudo random number bit string and a packet folding unit (to be simply referred to as a folding unit hereinafter) 122.

In the XOR unit 121, XOR between a packet and a pseudo random number bit string is performed. In this embodiment, the start position of XOR is fixed to the start position of the pseudo random number bit string generated by the pseudo random number bit string storing means 114. The packet folding unit 122 is used when the length plen of a packet is larger than the length streamlength of a pseudo random number bit string. A length surplus (unit: byte) of a part of the packet in which the XOR between the packet and the pseudo random number bit string is not completely performed (to be simply referred to as a surplus part hereinafter) will be defined:

surplus:=plen−streamlength

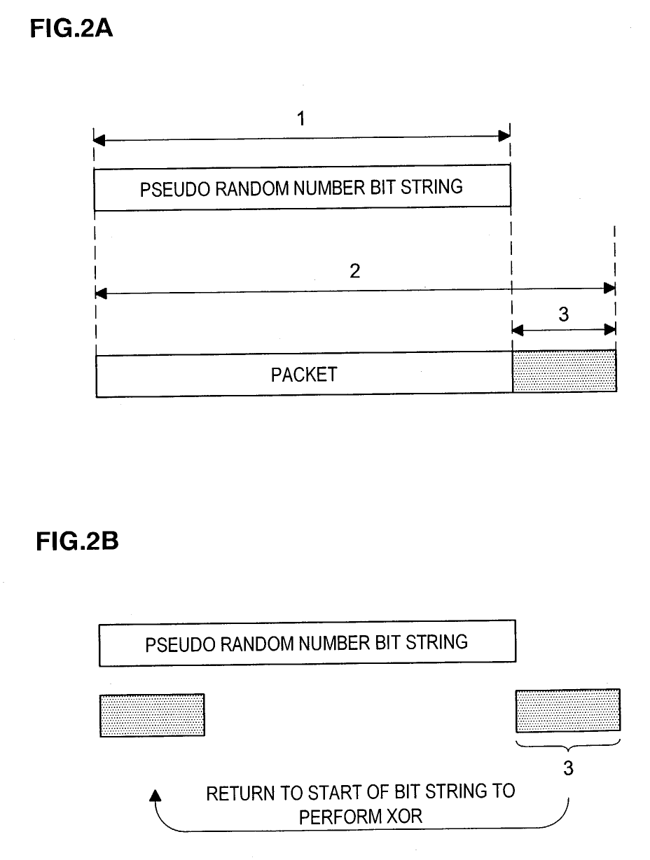

FIGS. 2A and 2B are diagrams for explaining a folding operation.

FIG. 2A shows definition of a surplus part surplus. This embodiment, as shown in FIG. 2B, is characterized in that a surplus part corresponding to the length surplus is returned to the start position of the pseudo random number bit string to perform XOR.

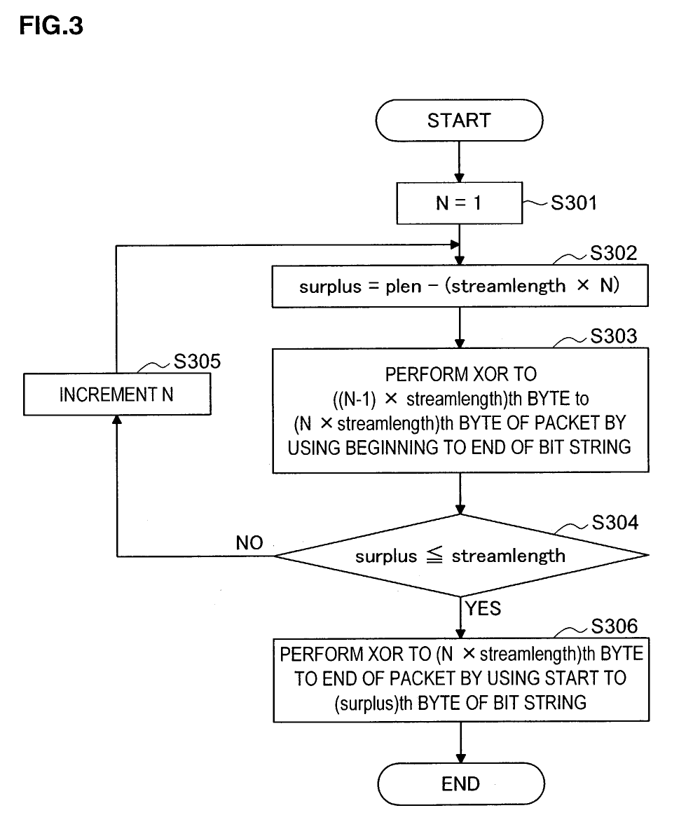

FIG. 3 is a flow chart showing an operation of the folding unit 122.

As an initial value, the number of times of hold N=1 is set (step S301). The length surplus of the surplus part of the packet in which XOR between the packet and the pseudo random number bit string is not completely performed is defined as follows (step S302).

surplus:=plen−streamlength×N

In this state, the folding unit 122 performs XOR to the ((N−1)×streamlength)th byte to the (N×streamlength)th byte of a packet by using the start position of the pseudo random number bit string to the end position of the pseudo random number bit string (step S303).

The length surplus of the surplus part is compared with the length streamlength of the pseudo random number bit string (step S304). If surplus>streamlength is satisfied, N is incremented (step S305), XOR of the streamlength byte of the packet is performed XOR by using all pseudo random number bit strings. This operation is repeated until the length surplus of the surplus part of the packet is equal to or less than the length streamlength of the pseudo random number bit string.

Finally, when the length surplus of the surplus part is equal to or less than the length streamlength of the pseudo random number bit string, by using the beginning of the pseudo random number bit string to the (surplus)th byte, XOR is performed to the surplus part of the packet (step S306).

The above operation is the operation of the folding unit 122.

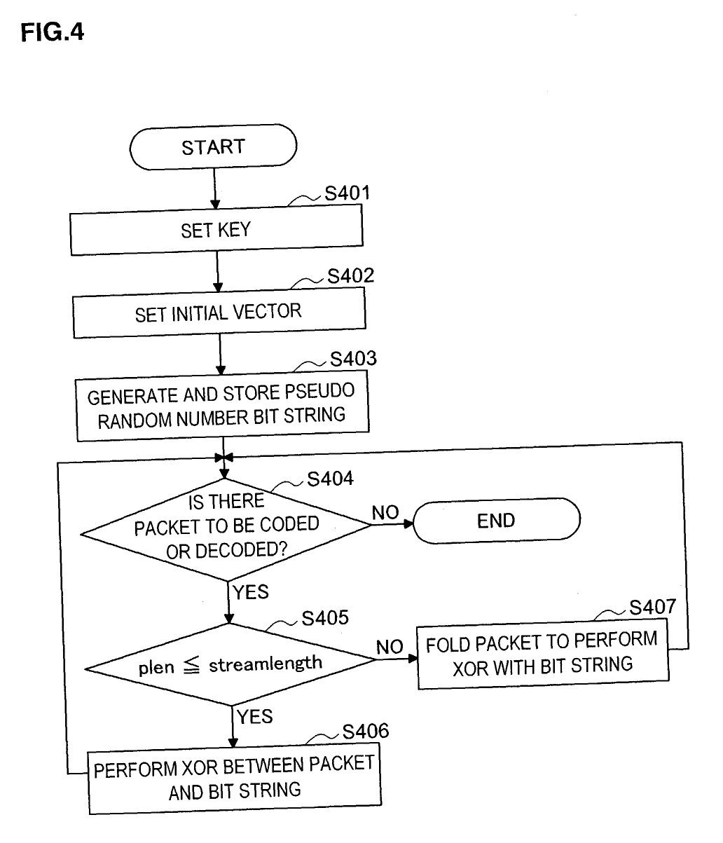

FIG. 4 is a flow chart for explaining an operation of this embodiment.

A key and an initial vector are set (steps S401 and S402). The maximum value maxplen of a packet length is input to generate a pseudo random number bit string having a length of maxplen×4 (step S403). Since the three steps S401 to S403 are called “preparation of pseudo random number bit string” in the specification and the drawings in the second and subsequent embodiments, an overlapping description will be omitted.

When there is no packet to be coded or decoded, the process is ended (step S404). When the length plen of a packet is smaller than the length streamlength of a pseudo random number bit string (step S405), as shown in FIG. 3, XOR between the packet and the pseudo random number bit string is performed (step S406).

In this embodiment, the start position of XOR is uniformly set as the start position of a pseudo random number bit string. The length plen of a packet is larger than the length streamlength of a pseudo random number bit string, as shown in FIGS. 2A and 2B, the packet is folded to perform XOR (step S407). When there is no packet to be coded or decoded, the process is ended.

(Effect of First Embodiment)

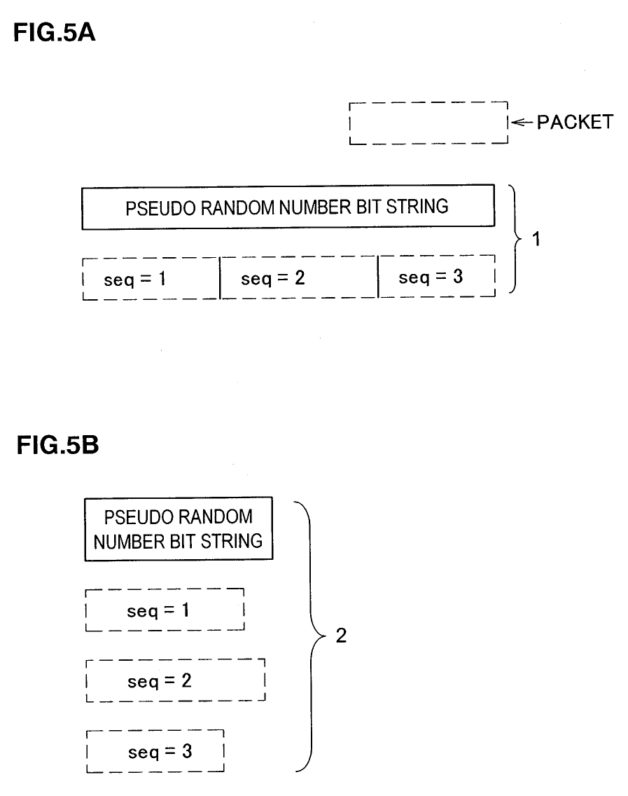

FIGS. 5A and 5B are diagrams for explaining positional relationships between pseudo random number bit strings and packets in this embodiment.

As described above, according to this embodiment, when a pseudo random number bit string having a predetermined length is generated first, only XOR may be performed. In ordinary OFB, as shown in FIG. 5A, a pseudo random number bit string having a length equal to the length of a packet must be generated. However, in this embodiment, as shown in FIG. 5B, when once pseudo random number bit string is generated, only XOR is may be performed. A high-speed operation and memory saving can be realized.

FIG. 30 is a diagram for explaining results of speed tests in this embodiment and the second to fourth embodiments which will be described later. In FIG. 30, a “mode” represents the nth embodiment as a mode n. In this embodiment, when a case in which a movie is transmitted such that the movie is divided into, e.g., 1000 packets is considered, steps S401 to S403 in FIG. 4 may be performed only once. In this point, steps S401 to S403 must be performed to all the 1000 packets in a conventional technique.

(Second Embodiment)

In this embodiment, a specific part of a pseudo random number bit string which is to be used in XOR is determined depending on a packet number seq. In this manner, the device is good at traffic analysis, and security is improved. Although it will be described later, a processing speed is rarely different from that of the first embodiment, and security can be improved without sacrificing the speed.

(Configuration of Second Embodiment)

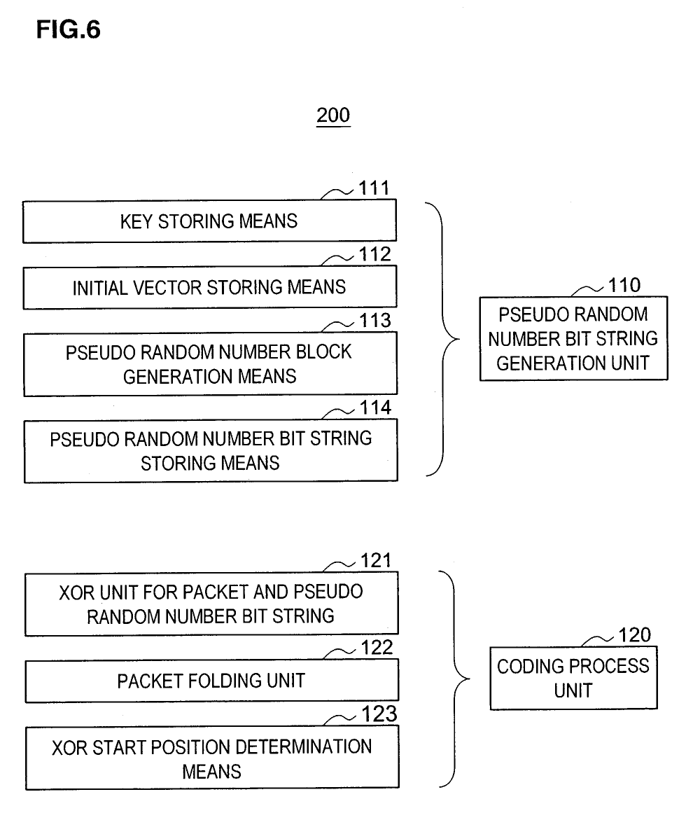

FIG. 6 is a diagram for explaining the configuration of a coding process device 200 according to this embodiment. The coding process device 200, as shown in FIG. 6, comprises two constituent elements, i.e., a pseudo random number bit string generation unit 110 and a coding process unit 120. Since the configuration of the pseudo random number bit string generation unit 110 is substantially the same as that of the first embodiment, an overlapping description will be omitted. In the coding process unit 120, an XOR start position determination means 123 is added to the configuration of the first embodiment to improve the packet folding unit 122.

(XOR Start Position Determination Means 123)

In the XOR start position determination means 123, depending on a packet number seq, a specific range of a pseudo random number bit string which is to be used is determined. This method will be described below in due order.

As the first step, the (seq×n)th byte from the beginning of a pseudo random number bit string is set as a start position as a start position of a pseudo random number bit string to which XOR with a packet is performed. In this embodiment, for descriptive convenience, n=4 is satisfied. However, the length of a pseudo random number bit string on packaging is actually finite, seq×4 cannot be continued.

When the following condition is satisfied:

seq×4<streamlength,

the position of seq is related to a position on the pseudo random number bit string. When the packet runs off the pseudo random number bit string, the packet may be folded on the same pseudo random number bit string. The folding method will be described in the description of the operation of the folding unit 122.

Since the value of seq increases to the number of packets, i.e., the theoretically maximum value, when seq×4 is directly used, the value exceeds the length of the pseudo random number bit string. More specifically, when seq×4≧streamlength, i.e., seq≧maxplen is satisfied, seq exceeds the length of the pseudo random number bit string. A method of setting the start position of XOR in that case will be described below.

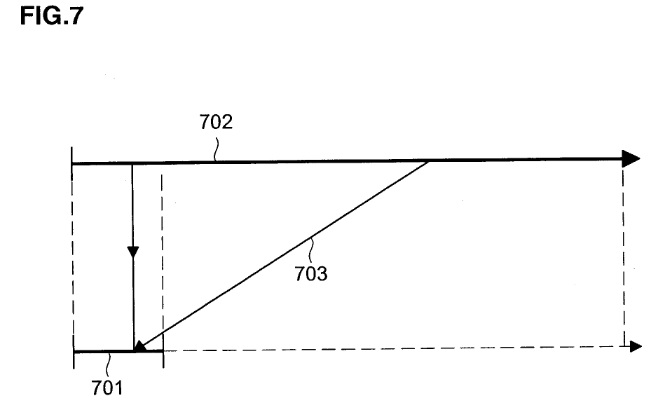

FIG. 7 is a diagram for explaining an operation of the XOR start position determination means 123.

In FIG. 7, reference numeral 701 denotes a pseudo random number bit string on packaging, and reference numeral 702 denotes a theoretical pseudo random number bit string. In the pseudo random number bit string 701, streamlength may be subtracted from position such that a start position position at which XOR between the pseudo random number bit string 701 and a packet is performed is smaller than streamlength. Therefore, as indicated by reference numeral 703 in FIG. 7,

position=(seq×4)mod streamlength

is set as the start position of the pseudo random number bit string to which XOR with packet is performed. More specifically, parts separated at intervals of streamlength in the theoretical pseudo random number bit string 702 are the same as those in the pseudo random number bit string 701 on packaging.

The XOR unit 121 actually performs XOR between a pseudo random number bit string and a packet. In the first embodiment, the start position of XOR is fixed to the start position of the pseudo random number bit string. In this embodiment, the start position of XOR is determined by the XOR start position determination means 123. Accordingly, the folding unit 122 must be changed.

A sum of the start position position of XOR and the length plen of the packet is smaller than the length streamlength of the pseudo random number bit string, i.e., when

position+plen<streamlength

is satisfied, XOR is performed without folding the packet.

On the other hand, when the sum of the start position position of XOR and the length plen of the packet is larger than the length streamlength of the pseudo random number bit string, i.e., when

position+plen≧streamlength

is satisfied, the packet must be folded. In order to check whether the packet is folded or not, a surplus part surplus=(position+plen)−streamlength (unit: byte) is calculated. If surplus is larger than 0, the packet is folded.

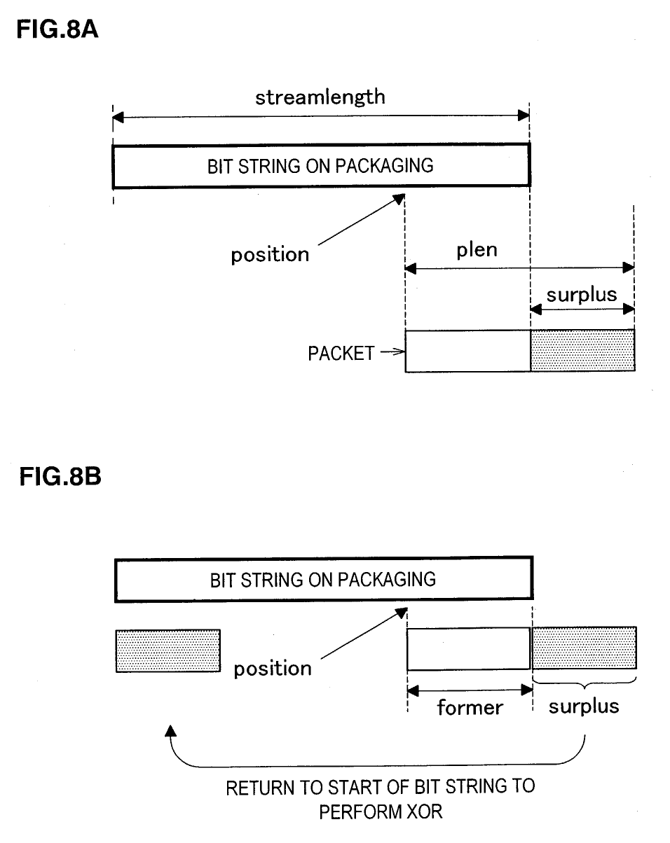

FIG. 8 is a diagram for explaining a packet folding operation in this embodiment.

On the assumption that surplus<streamlength is satisfied, a packet folding method will be described below.

The length plen of the packet is divided into the first-half bit former and a surplus part surplus. More specifically,

former=plen−surplus

This first-half bit former is also a distance between the start position position to the end position of the pseudo random number bit string.

As shown in FIG. 8A, XOR between a packet and a pseudo random number bit string is performed to a packet of former bytes starting from the start position position. In this manner, the XOR process can be performed to the first-half part of the packet. As shown in FIG. 8B, XOR with the surplus part to which XOR with a packet is not performed is performed from the beginning of the pseudo random number bit string. For this reason, XOR can be performed to the entire packet.

When surplus>streamlength is satisfied, as described in the first embodiment, XOR is performed to the packet every streamlength by the entire pseudo random number bit string. The second embodiment is the same as the first embodiment except that XOR of a packet of former bytes is performed first.

(Operation of Second Embodiment)

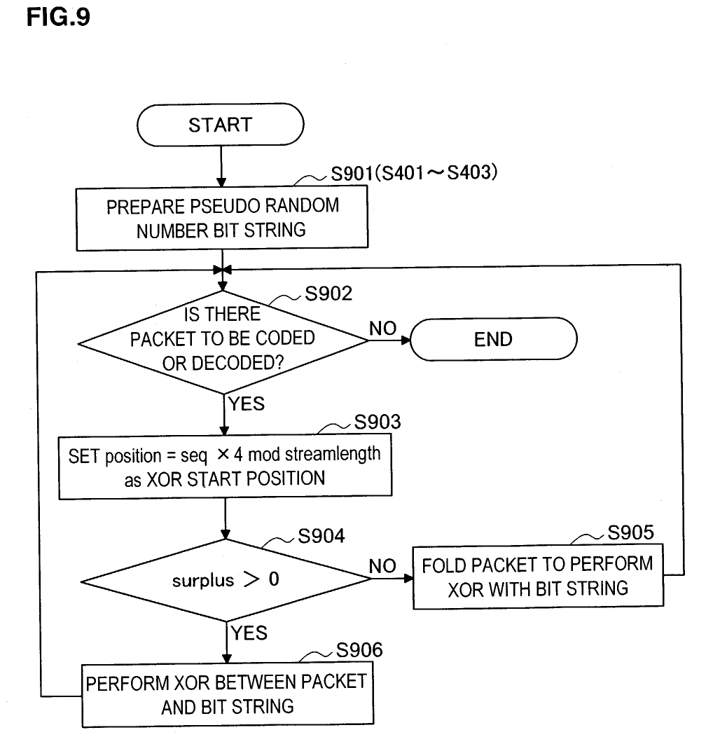

FIG. 9 is a diagram for explaining an operation of this embodiment.

A pseudo random number bit string is prepared by the pseudo random number bit string generation unit 110 (step S901). Since the operation of the pseudo random number bit string generation unit 110 is substantially the same as that of the first embodiment, an overlapping description will be omitted. When there is no packet to be coded or decoded, the process is ended (step S902). By using the XOR start position determination means 123, the start position position of XOR in the pseudo random number bit string is determined as:

position=seq×4 mod streamlength

(step S903). The second embodiment is different from the first embodiment in step S903.

Calculation:

surplus=position+plen−streamlength

is performed. If surplus>0 is satisfied (step S904), a packet is folded to perform XOR (step S905). If surplus>0 is not satisfied, XOR between a packet and a pseudo random number bit string is performed to plen bytes starting from the (position)th byte of the pseudo random number bit string by the coding process unit 120 (step S906). When a packet having a length larger than streamlength is processed, loop is performed. In the second embodiment, decoding can be performed regardless of the order of reception of packets. The three steps S904 to S906 are called “XOR between a packet and a pseudo random number bit string” in the specification and the drawings in the third and subsequent embodiments, an overlapping description will be omitted.

(Effect of Second Embodiment)

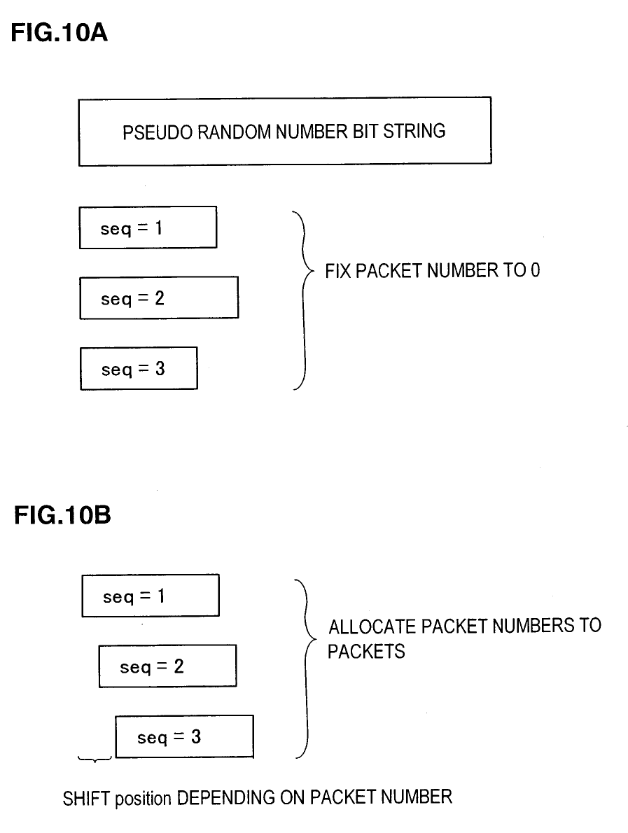

FIGS. 10A and 10B are diagrams for explaining a positional relationship between a packet and a pseudo random number bit string in this embodiment.

In this embodiment, a pseudo random number bit string used in XOR is updated depending on a packet, so that security is improved in comparison with the security of the first embodiment. As shown in FIG. 10A, XOR can also be performed from the start position of the pseudo random number bit string. In this case, the same operation as that in the first embodiment is performed. As shown in FIG. 10B, a start position at which XOR between a packet and a pseudo random number bit string is performed can be made variable.

As shown in FIG. 30, a processing speed is rarely different from that of the first embodiment, and security can be improved without sacrificing the speed.

(Third Embodiment)

This embodiment is characterized in that a pseudo random number bit string is updated by applying the second embodiment. In this manner, a pseudo random number bit string on packaging stored on a memory can simulate a theoretical pseudo random number bit string. In the third embodiment, security can be considerably improved in comparison with the first and second embodiment in which a pseudo random number bit string of predetermined length is generated first and continuously used.

(Configuration of Third Embodiment)

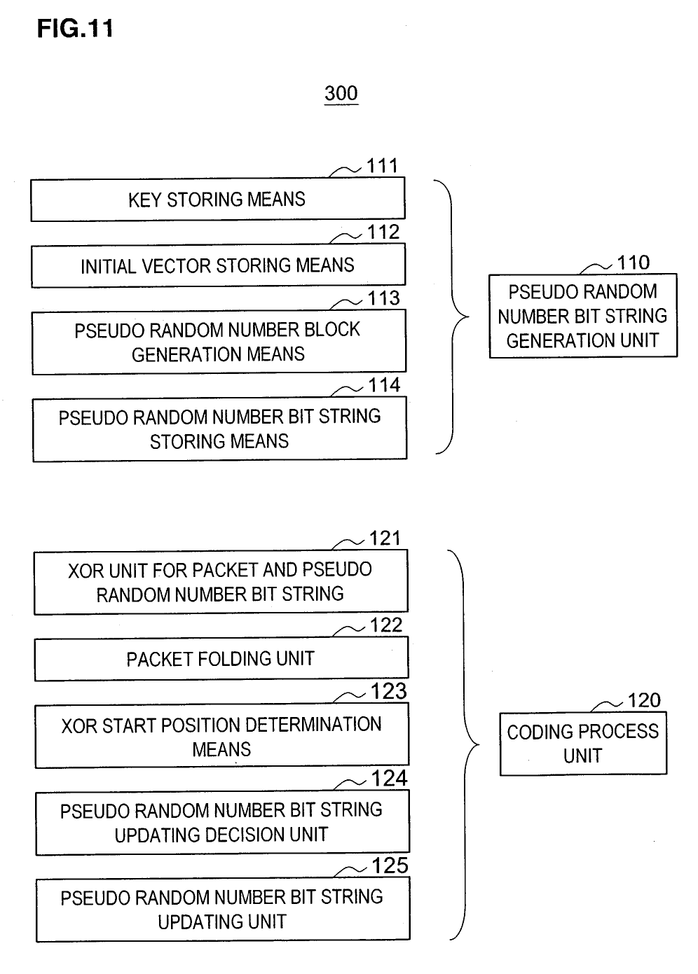

FIG. 11 is a diagram for explaining the configuration of a coding process device 300 according to this embodiment. The coding process device 300, as shown in FIG. 11, comprises two constituent elements, i.e., a pseudo random number bit string generation unit 110 and a coding process unit 120. Since the configuration of the pseudo random number bit string generation unit 110 is substantially the same as that of the first embodiment, an overlapping description will be omitted. The coding process unit 120 is constituted such that a decision unit (to be referred to as an updating decision unit hereinafter) 124 for updating a pseudo random number bit string and a pseudo random number bit string updating unit (to be referred to as an updating unit hereinafter) 125 are added to the configuration of the second embodiment.

Before the updating decision unit 124 and the updating unit 125 are explained, how to simulate a theoretical pseudo random number bit string by a pseudo random number bit string on packaging stored on a memory will be described below. This embodiment copes with the two following functions by applying the second embodiment.

A pseudo random number bit string on packaging is generated in advance.

A specific part of a pseudo random number bit string on packaging used for performing a coding process is determined depending on a packet number seq. More specifically, the start position position of the coding process is determined (position=seq×4 mod streamlength).

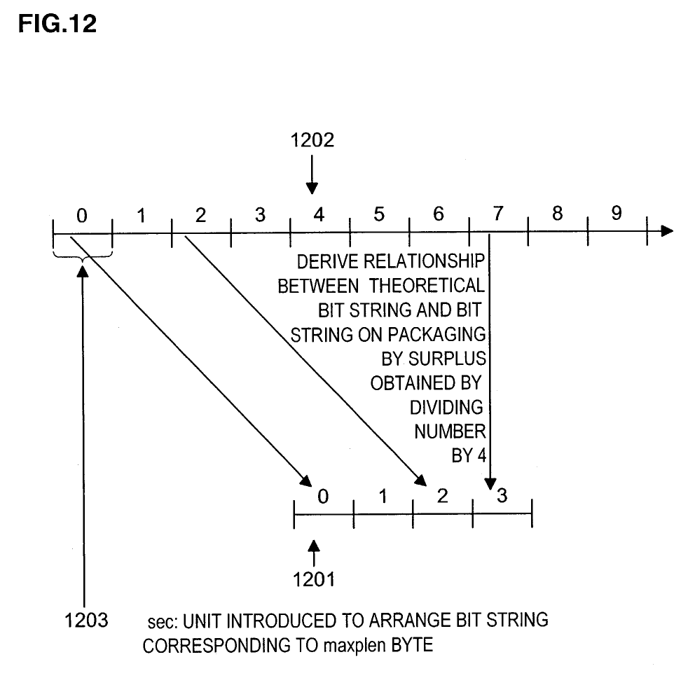

FIG. 12 is a diagram for explaining division of a pseudo random number bit string into sec units.

In FIG. 12, reference numeral 1201 denotes a pseudo random number bit string on packaging, and reference numeral 1202 denotes a theoretical pseudo random number bit string.

Before a concrete explanation, a pseudo random number bit string is described in units called sections (sec). The sec is a unit corresponding to the maximum value maxplen of the length of the packet (reference numeral 1203 in FIG. 12). The theoretical pseudo random number bit string and the pseudo random number bit string on packaging are discriminated from each other as follows:

sec of the theoretical pseudo random number bit string 1202: T_sec

sec of the pseudo random number bit string 1201 on packaging: I_sec

Numbers 0, 1, 2, 3, 4, 5, . . . are added to the theoretical pseudo random number bit string 1202 every 1 sec. Similarly, numbers 0, 1, 2, 3 are added to the pseudo random number bit string 1201 on packaging having a length of maxplen×4. The reason why sec is used is as follows. More specifically, since the pseudo random number bit string on packaging is a constant (in this case, 4 times) of maxplen, a calculation can be simplified by using maxplen as one unit. Infinite numbers are added to the theoretical bit string because it is understood that sec having the length of maxplen infinitely continues in the theoretical pseudo random number bit string.

As a simulation method, as shown in FIG. 12, T_sec (N) which satisfies N=j+4k (k: an integer which is zero or more) is input to each I_sec (j) (j=0, 1, 2, 3). For example, when I_sec (1), T_sec (1), T_sec (1+4), . . . , T_sec (1+4k) may be input. This is because it is understood that a bit string (in this case, four secs are aligned) on packaging infinitely continues in the theoretical bit string. In this manner, parts which are separated at intervals of streamlength (=maxplen×4) in the theoretical pseudo random number bit string can also be used on packaging.

(Updating unit 125)

The updating unit 125 will be described below. In the updating unit 125, a pseudo random number bit string is updated every sec described above. As shown in FIG. 12, the pseudo random number bit string is divided into 4 secs. The pseudo random number bit string may be updated into 5 or more secs. However, when a packet having an arbitrary length:

0<plen<maxplen

is processed, in order to make easy to decide whether the pseudo random number bit string is updated or not, the pseudo random number bit string is updated every maxplen. The updating decision unit 124 decides whether updating is performed or not, and determines a part to be updated.

As a concrete updating procedure, when a section number to be updated in a theoretical pseudo random number bit string is represented by N, the contents of I_sec (N mod 4) may be updated from T_sec (N) to T_sec (N+4). In order to generate T_sec (N+4), a pseudo random number bit string may be generated by using the final predetermined length byte (In Rijndael, any one of 16, 24, or 32 bytes. These bytes are called a block hereinafter.) of T_sec (N+3) as an initial vector. However, in this case, a pseudo random number bit string corresponding to T_sec (N+3) must reliably exist when I_sec (N mod 4) is updated. However, the updating may be performed in the order of N=1, 2, . . . . In this manner, when I_sec (N mod 4) is updated, I_sec (N−1 mod 4) is updated, and the contents thereof are represented by T_sec (N+3).

(Updating decision unit 124)

In the updating decision unit 124, it is decided depending on a packet number seq whether a pseudo random number bit string is updated or not. The updating unit 125 actually updates the pseudo random number bit string. In this embodiment, on the assumption that the packet number seq monotonously increases, i.e., the following condition is satisfied:

seq(j+i)>seq(j),

a decision for updating is performed.

Here, seq (●) will be described.

J:={1, 2, 3, . . . }

is set as an order of packets to be coded and decoded. In this state, with respect to an arbitrary j∈J

J→seq(j)

is set as a packet number corresponding to a packet. For example, seq (j+i) means a packet number given to a packet which is processed in the (i+j)th place. In this case, i=1, 2, 3, 4 may not be necessarily satisfied.

Since the packet number seq monotonously increases, when a packet number corresponding to T_sec (N+1) appears, i.e., when the packet number seq satisfies:

seq×4≧maxplen×(N+1) (updating condition),

pseudo random number bit strings before T_sec (N) are not necessary. This means that the pseudo random number bit strings before the packet number reaches the position of (b): seq (j) are not necessary. This is effected in a pseudo random number bit string on packaging.

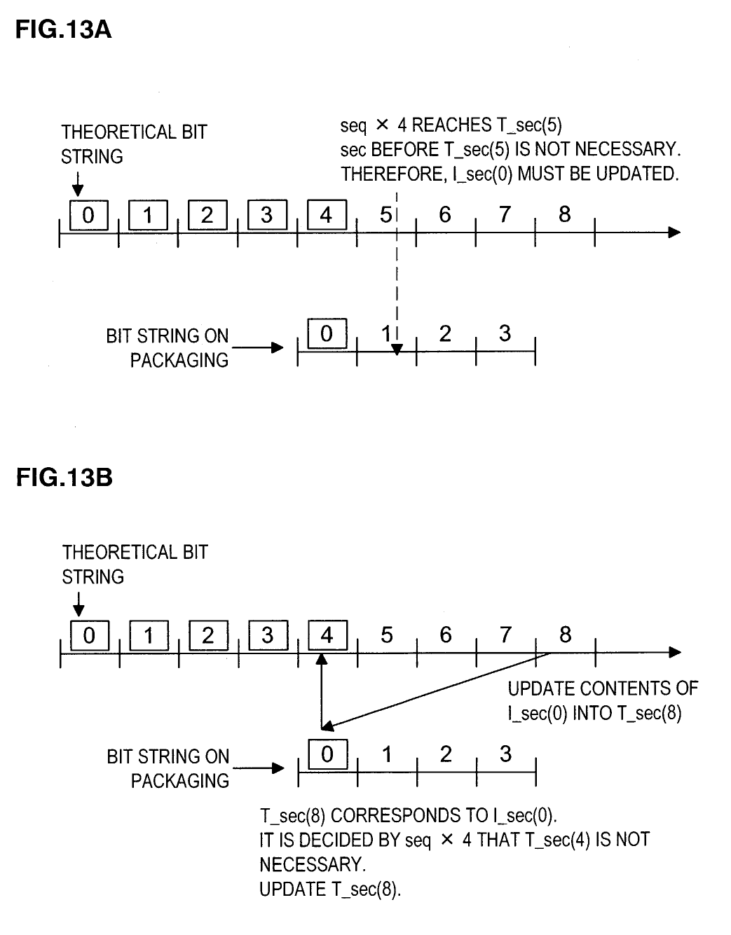

FIGS. 13A and 13B diagrams for explaining an example of updating of a pseudo random number bit string according to this embodiment. FIG. 13A shows a decision for updating depending on seq, and FIG. 13B shows updating of a corresponding pseudo random number bit string.

When the condition (updating condition) is satisfied, I_sec (N mod 4) corresponding to T_sec (N) is updated. More specifically, T_sec (N) smaller than I_sec (N mod 4) is updated into T_sec (N+4). Upon completion of the updating, N is incremented, and the (updating condition) is checked. When the condition is satisfied, updating is continued. The updating is continuously performed until the updating is not necessary.

For example, a case in which seq×4 moves from T_sec (4) to T_sec (5) will be considered. As shown in FIG. 13A, since a packet number monotonously increases, a pseudo random number bit string corresponding to T_sec (4) is not necessary any more. I_sec (0) corresponds to T_sec (4). I_sec (0) need not include a pseudo random number bit string corresponding to T_sec (4). Therefore, as shown in FIG. 13B, the contents of I_sec (0) may be updated into T_sec (8).

(Operation of Third Embodiment)

The entire operation of this embodiment and an updating operation of a pseudo random number bit string will be separately described below.

With respect to the entire operation, this embodiment is considerably different from the first and second embodiments in that a pseudo random number bit string is updated.

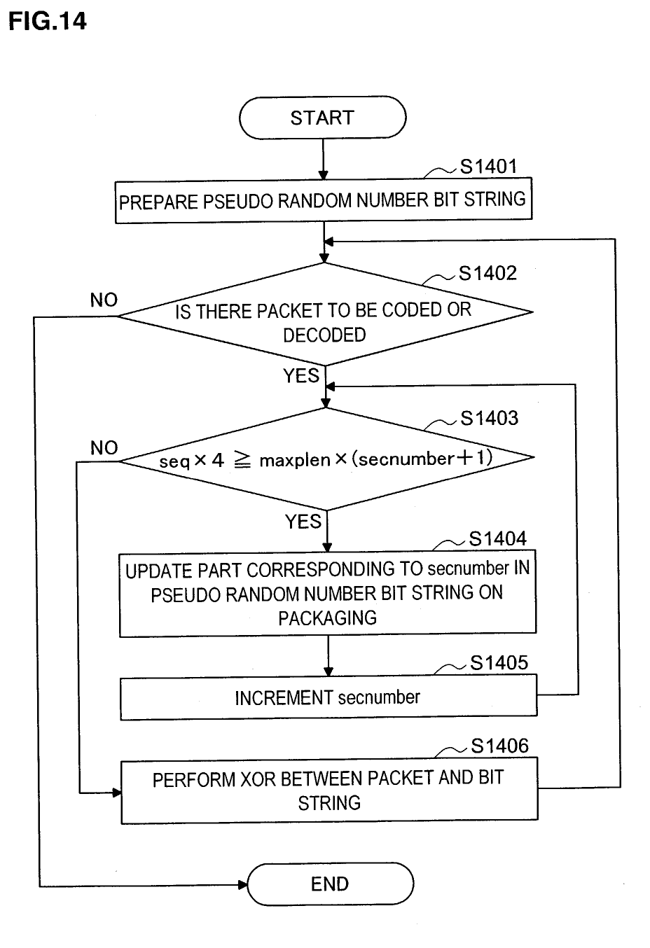

FIG. 14 is a diagram for explaining the entire operation of this embodiment.

A pseudo random number bit string is prepared (step S1401). Since this is substantially the same as the operation up to the second embodiment, an overlapping description will be omitted. As a unique operation performed in the third embodiment, secnumber is prepared as a parameter for describing a section to be updated, and is initialized as 0. When there is no packet to be coded or decoded, the process is ended (step S1402).

It is decided whether seq given to each packet satisfies the following expression:

seq×4≧maxplen×(secnumber+1)

or not (step S1403). When seq satisfies the expression, a section determined by secnumber is updated (step S1404). The details of the updating operation will be described later. After the updating, secnumber is designed to satisfy:

maxplen×secnumber≦seq×4≦maxplen×(secnumber+1).

After the pseudo random number bit string is updated, secnumber is incremented (step S1405), and in step S1403, steps S1403 to S1405 are repeated until the following expression is satisfied:

seq×4maxplen×(secnumber+1).

After this condition is satisfied, XOR between a packet and a pseudo random number bit string is performed (step S1406). Since this XOR is substantially the same as that in the second embodiment, an overlapping description will be omitted.

However, when a packet having a length of plen>maxplen×2 is to be processed, coding and decoding may be performed by using a section which has not been updated. When security is not considered, the section which has not been updated may be directly used. In this case, an application to special reproduction (will be described in the fifth embodiment) is not assured. A measure against a problem in which a processible packet has a limited length will be described in the sixth embodiment.

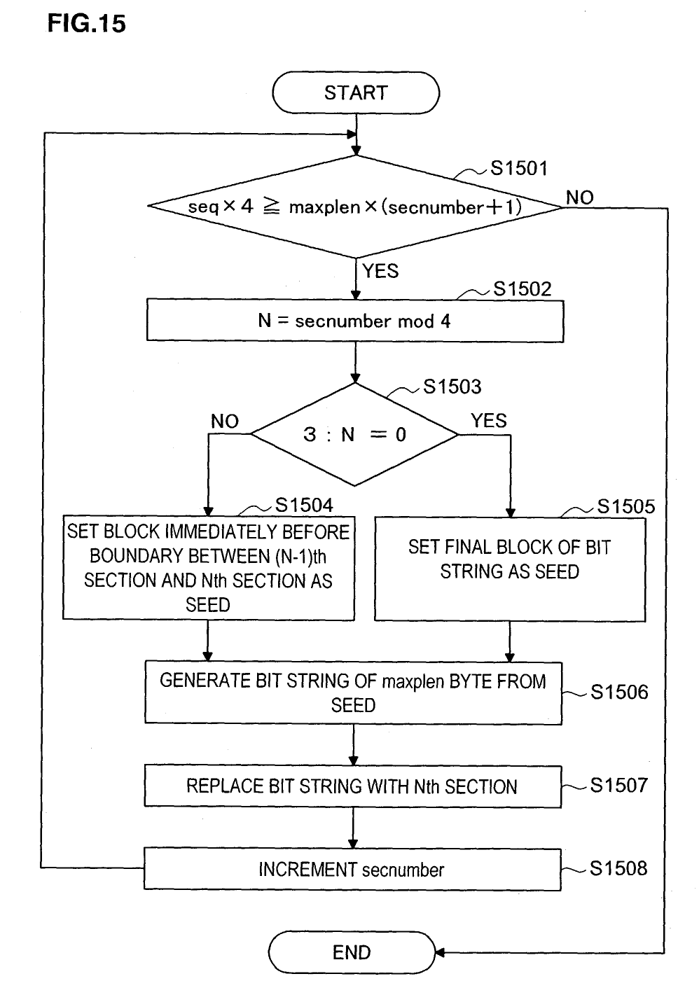

FIG. 15 is a diagram for explaining an operation for updating a pseudo random number bit string.

It is decided whether seq given to each packet satisfies the following expression:

seq×4≧maxplen×(secnumber+1)

or not (step S1501). A specific section to be updated in a pseudo random number bit string on packaging is determined. When the section to be updated is represented by N, N is derived by the following equation:

N=secnumber mod 4

(step S1502). This depends on that the pseudo random number bit string on packaging is constituted by four sections.

When N=0 is not satisfied (step S1503), several bytes (which vary depending on a coding function to be used. In Rijndael, any one of 16, 24, 32 bytes is selected. These bytes are called a block hereinafter.) immediately before a boundary between the (N−1)th section and the Nth section are used as an initial vector (seed) to generate a pseudo random number bit string having a length of maxplen bytes (step S1504 and S1506). When N=0 is satisfied, the final block of the pseudo random number bit string on packaging is used as an initial vector (seed) to generate a pseudo random number bit string having a length of maxplen bytes (steps S1505 and S1506). The bit string having the length of maxplen bytes and generated as described above is replaced with the Nth section of the pseudo random number bit string on packaging (step S1507).

Finally, secnumber is incremented (step S1508), and, by using the incremented secnumber, it is decided whether seq satisfies the following expression:

seq×4≧maxplen×(secnumber+1).

This is a prevention against a large jump of seq. When a series of updating operations are completed, secnumber must satisfy the following expression:

maxplen×secnumber≦seq×4≦maxplen×(secnumber+1).

(Effect of Third Embodiment)

In this embodiment, a pseudo random number bit string on packaging is updated. For this reason, security is higher than those in the first and second embodiments.

As shown in FIG. 30, when a packet number is increased one by one, a speed which is not largely different from that in the first or second embodiment. In addition, even though the packet number is increased (packet length)/4 by (packet length)/4, a speed which is almost equal to that of conventional OFB can be achieved. When the performance in this embodiment is compared with the performance in a conventional OFB, it can be said that packet loss resistance is improved without sacrificing a simple speed when a packet loss does not occur.

(Fourth Embodiment)

The third embodiment is limited such that a packet number must monotonously increase. In the fourth embodiment, the packet number is designed to be reversed to some extent by changing the third embodiment as follows.

The length of a pseudo random number bit string on packaging is made equal to or larger a predetermined length (3 times or more of maxplen).

An updating decision condition and an updating method are changed.

The configuration of this embodiment is substantially the same as the configuration of the third embodiment shown in FIG. 11. In the third embodiment, a condition in which a packet number monotonously increases, i.e., the following expression:

seq(i+1)>seq(i)

is satisfied is given. However, in the fourth embodiment, the following condition (condition A) with respect to a packet number is given:

seq(j+i)>seq(j)−maxplen/2 (condition A).

In this expression, maxplen is a value obtained when a pseudo random number bit string is generated.

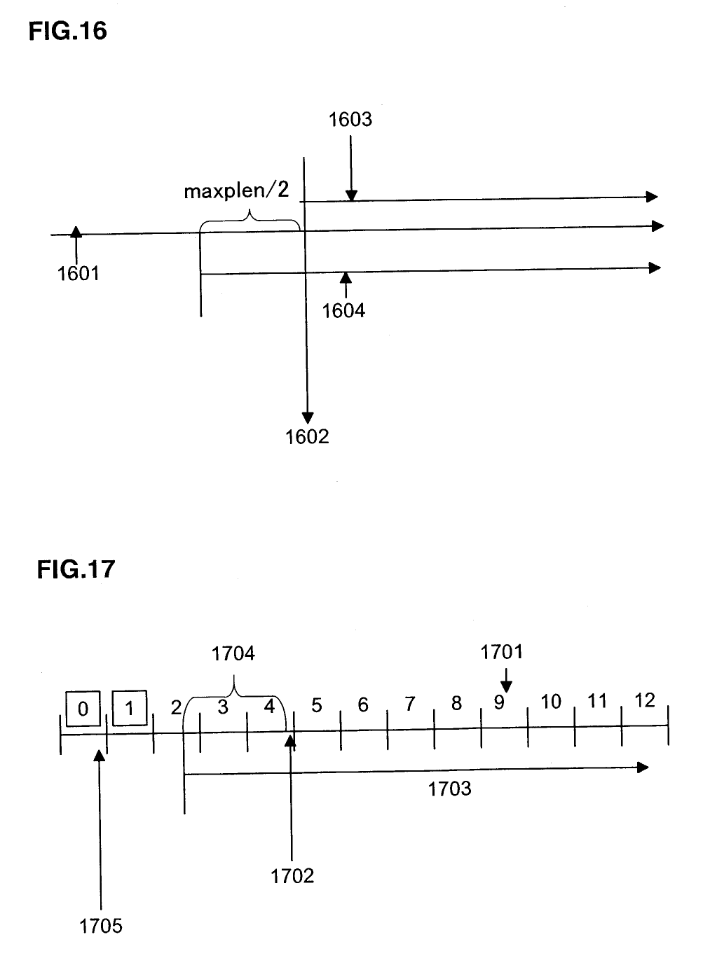

FIG. 16 is a diagram for explaining extension of the condition with respect to a packet number.

In this embodiment, the condition is extended until maxplen can be reversed to the half of maxplen. Reference numeral 1601 denotes a number line of natural numbers, and reference numeral 1602 denotes seq (j). Reference numeral 1603 denotes a range in which seq (j+i) falls when the packet number monotonously increases, and denotes seq (j) and subsequent numbers. On the other hand, reference numeral 1604 denotes a range in which seq (j+i) falls under (condition A), and denotes a part reversed by maxplen/2 from seq (j) and subsequent numbers. The “half of maxplen” is an equation which is derived because streamlength can be described as 4 times of maxplen and because a relationship between packet numbers and theoretical pseudo random number bit strings can be described by “packet number×4”. Accordingly, the operations of an updating decision unit 124 of the coding process unit 120, an updating unit 125, and a pseudo random number bit string extension unit 126 (to be described in the sixth embodiment) change. This point will be described below.

(Updating Decision Unit 124)

The updating decision unit 124 will be described below. Although the condition in the fourth embodiment is different from that in the third embodiment, in the fourth embodiment, a pseudo random number bit string is updated on the basis of facts that I_sec having unnecessary T_sec may be continuously updated as in the third embodiment. In a monotonous increase, the following method of thinking is employed. That is, when seq corresponding to T_sec (N+1) appears, a pseudo random number bit string before T_sec (N) is not necessary. In this embodiment, the following method of thinking may be used. That is, since a packet number can be reversed as in (condition A), when seq corresponding to T_sec (N+3) appears, a pseudo random number bit string before T_sec (N) is not necessary. More specifically, when the packet number seq satisfies the following expression:

seq×4≧maxplen×(N+3),

a pseudo random number bit string before T_sec (N) is not necessary. The reason why the pseudo random number bit string is not necessary will be described below.

First, (condition A) is updated. Both side members of the expression of (condition A) are multiplied by 4 to obtain (condition A′).

seq(j+i)×4>seq(j)×4−maxplen×2 (condition A′)

When seq is multiplied by 4, the position corresponds to the start position at which XOR is started on the theoretical pseudo random number bit string. For this reason, as a condition on the theoretical pseudo random number bit string, (condition A) can be updated into (condition A′).

FIG. 17 is a diagram for explaining (condition A′) on a bit string.

Reference numeral 1701 denotes a theoretical pseudo random number bit string, reference numeral 1702 denotes the position of seq (j)×4, reference numeral 1703 denotes a range in which seq (j+i)×4 can fall, reference numeral 1704 denotes maxplen×2, and reference numeral 1705 denotes T_sec 0 which is determined to be unnecessary on the basis of the value of seq (j). According to (condition A′), it is understood that to put seq (j) in T_sec (N+3) means that the subsequent packet number seq (i) requires a pseudo random number bit string subsequent to T_sec (N+1). On the contrary, a pseudo random number bit string before T_sec (N) is not necessary.

Conclusively, when seq×4 is in T_sec (N+3), a pseudo random number bit string before T_sec (N) is not necessary. By using this, updating of a pseudo random number bit string on packaging will be described below. In this case, I_sec having unnecessary T_sec may be updated as needed.

For example, seq×4 is smaller than T_sec (N), I_sec (N−3 mod 4) corresponding to T_sec (N−3) is updated. More specifically, T_sec (N−3) smaller than I_sec (N−3 mod 4) is updated into T_sec (N+1). This operation is continued until all parts before T_sec (N−3) are updated.

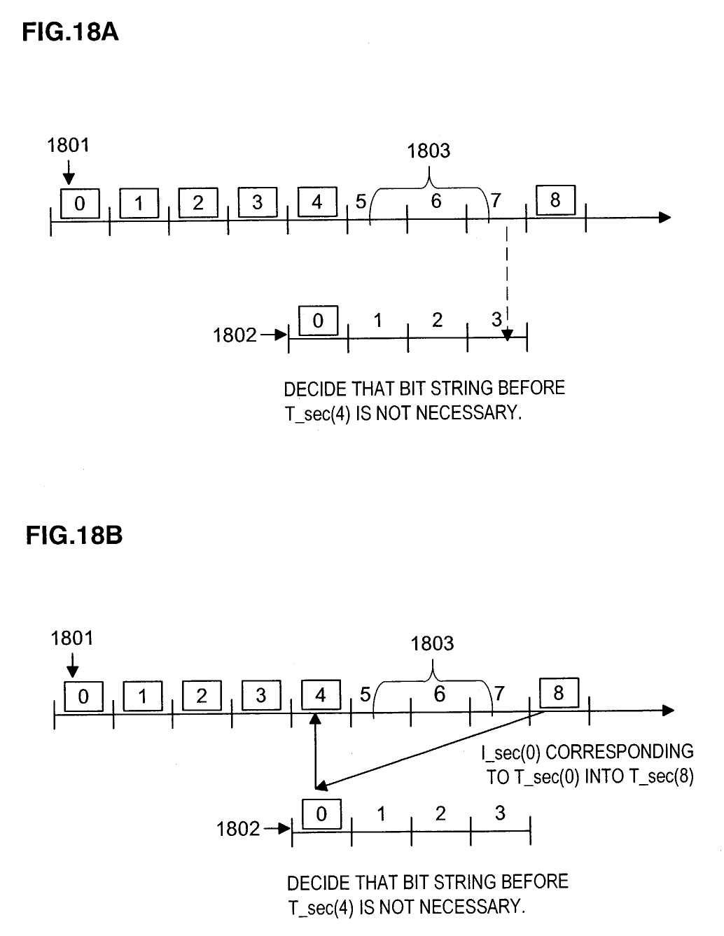

FIGS. 18A and 18B are diagrams for explaining a concrete example of updating in a pseudo random number bit string on packaging under (condition A′). For example, a case in which seq×4 moves from T_sec (6) to T_sec (7) will be considered. FIG. 18A shows specific sec which is selected to be updated when seq (j)×4 reaches T_sec (7). FIG. 18B shows how to actually perform updating. In addition, reference numeral 1801 denotes a theoretical pseudo random number bit string, reference numeral 1802 denotes a pseudo random number bit string on packaging, and reference numeral 1803 denotes maxplen×2.

1: According to (condition A), it is decided that a pseudo random number bit string corresponding to T_sec (4) is not necessary (FIG. 18A).

2: I_sec (0) corresponds to T_sec (4) (FIG. 18B).

3: According to (condition A), a pseudo random number bit string corresponding to T_sec (4) need not be in I_sec (0).

4: Since the start position of XOR is T_sec (7), and since the maximum of a packet length is equal to the length of each section, a pseudo random number bit string corresponding to T_sec (8) is necessary. Therefore, the contents of I_sec (0) may be updated into T_sec (8) (FIG. 18B).

(Operation of Fourth Embodiment)

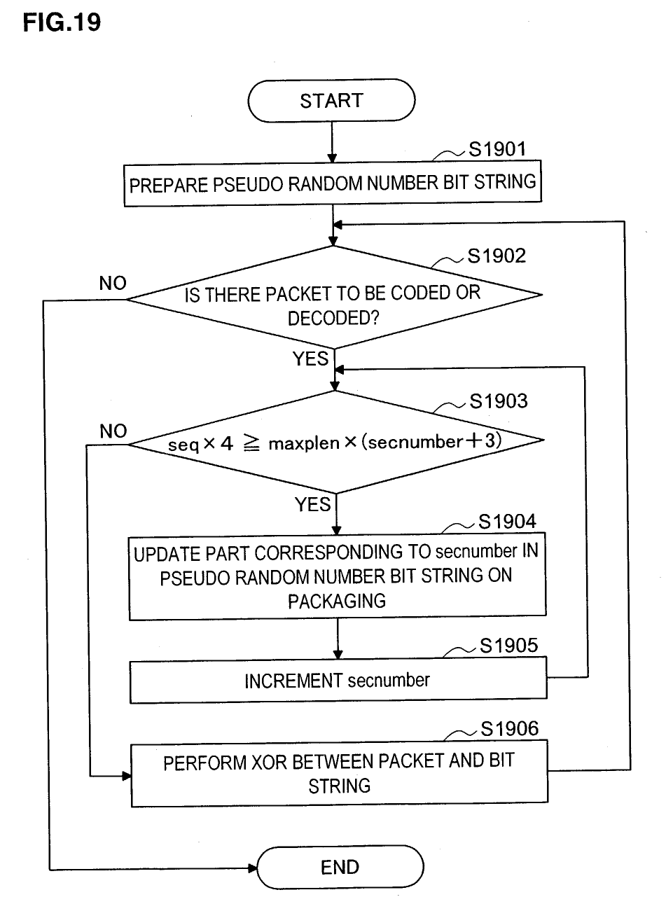

FIG. 19 is a diagram for explaining an operation of this embodiment.

The operation of this embodiment is substantially the same as the operation of the third embodiment shown in FIG. 14. The embodiment is different from the third embodiment in that decoding can be performed regardless of the order of reception of packets by the following three changes.

A pseudo random number bit string uses sufficiently long. A pseudo random number bit string uses, at least 3 times or more of maxplen.

Reference of updating decision is changed. More specifically, in step S1903, the following expression is used as an updating condition:

seq×4≧maxplen×(secnumber+3).

A section to be updated is changed. More specifically, in step S1904, a part corresponding to secnumber is updated in a pseudo random number bit string on packaging.

Other steps S1901, S1902, S1905, and S1906 are substantially the same as the corresponding steps in the third embodiment (step S1904).

(Effect of Fourth Embodiment)

According to this embodiment, decoding can be performed regardless of the order of reception of packets. In reception of live delivery using a protocol such as UDP (User Datagram Protocol) which does not assure the order of data reception, the order of packets is often disturbed. For this reason, the device must cope with the disturbance of the order to some extent. As shown in FIG. 30, a speed which is almost equal to that in the third embodiment can be achieved. The first and second embodiments are different from each other in that “regardless of order” is not completely established because a pseudo random number bit string is updated. However, as far as live delivery by streaming, when packets cannot be received on time, a lost packet is not reproduced. For this reason, a packet number need not be infinitely reversed. Therefore, when a packet number is reversed by an amount described in this embodiment, a sufficient effect can be achieved.

(Fifth Embodiment)

In this embodiment, a method of applying the device to a special reproducing operation such as a jump reproducing operation or a fast feeding/rewinding operation in movie delivery will be described below. A common drawback of these operations is that a packet number largely varies. As in the first and second embodiments, when a pseudo random number bit string having a predetermined length is entirely used, any problem is not posed. However, in the third and fourth embodiments in which a pseudo random number bit string on packaging is used while being updated, when a packet number largely varies, many pseudo random number bit strings must be generated and updated. A method for solving the problem will be described in this embodiment.

(Configuration of Fifth Embodiment)

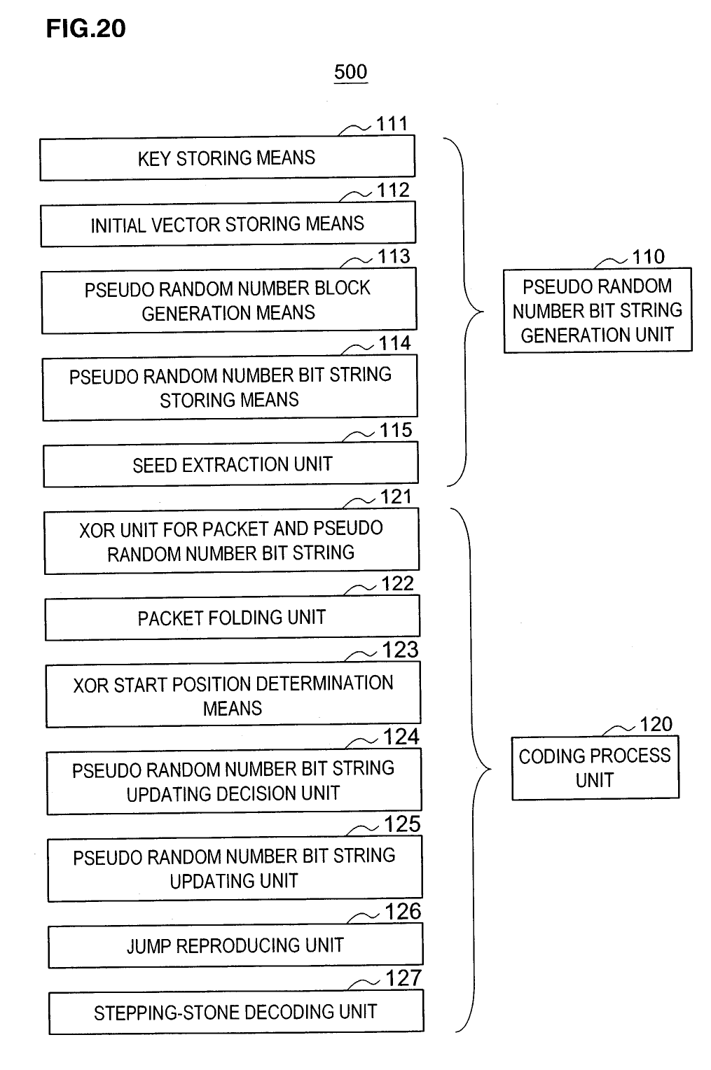

FIG. 20 is a diagram for explaining the configuration of a coding process device 500 according to this embodiment. The coding process device 500, as shown in FIG. 20, comprises two constituent elements, i.e., a pseudo random number bit string generation unit 110 and a coding process unit 120. The pseudo random number bit string generation unit 110 adds a seed extraction unit 115 to the configuration of the first embodiment. The coding process unit 120 is obtained by adding a jump reproduction unit 126 and a stepping-stone decoding unit 127 to the configuration of the third embodiment. These added constituent elements will be briefly described below. The seed extraction unit 115 is a constituent element for extracting an initial vector (to be referred to as a seed of a packet hereinafter) for generating a pseudo random number bit string corresponding to a packet number. The jump reproduction unit 126 is a constituent element which uses an input packet number as an initial value to start decoding from the initial value. The stepping-stone decoding unit 127 is a constituent element which decodes only a designated packet.

(Seed Extraction Unit 115)

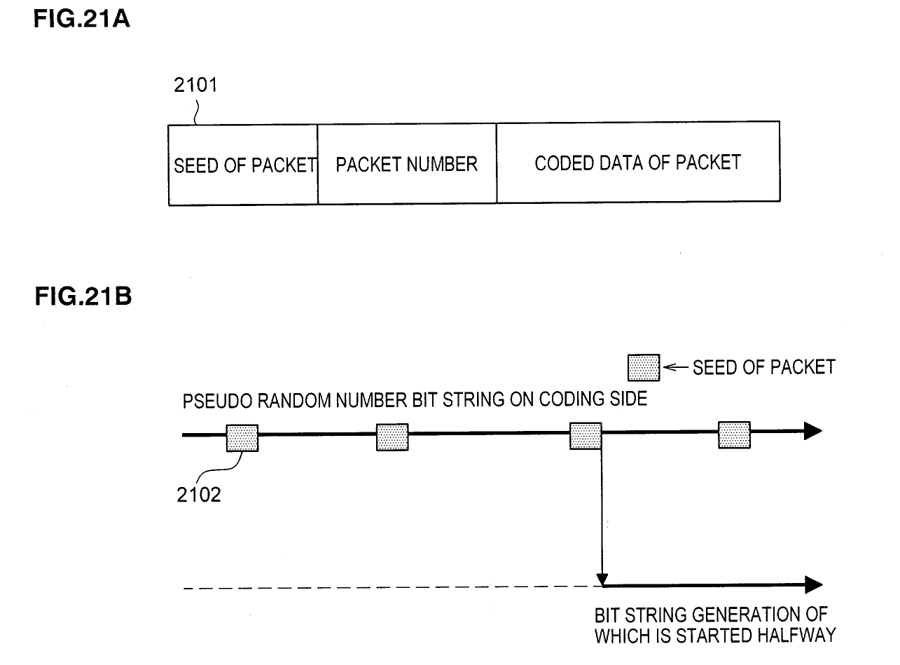

FIGS. 21A and 21B are diagrams for explaining the function of the seed extraction unit 115. FIG. 21A shows the image of accumulated packets, and FIG. 21B shows a pseudo random number bit string.

The seed extraction unit 115 designates a packet number seq, and is required for preparation for decoding from the packet number seq. The seed extraction unit 115 assumes the following situation.

Decoded data is accumulated in a server on transmission side in units of packets.

Packets are accumulated in the form of packet+packet number.

On this assumption, at predetermined cycles of several to several hundred packets, as shown in FIG. 21A, a bit string having a predetermined length required to generate a pseudo random number bit string required to decode the packets is held. The length of the bit length is determined by a coding function to be used. As shown in FIG. 21B, the bit string corresponds to a “bit string having predetermined length” immediately before a position where XOR between the pseudo random number bit string and packet is started on the pseudo random number bit string. The bit string corresponds to a “seed of packet” described above. According to this, when a packet number seq is designated, decoding can be performed by using a “seed of packet” closest to the packet number seq as an initial vector.

(Jump Reproduction Unit 126)

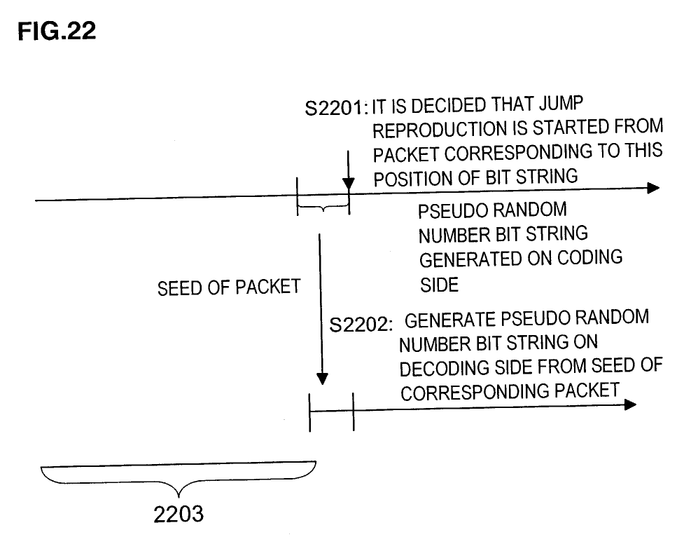

FIG. 22 is a diagram for explaining the function of the jump reproduction unit 126.

In the jump reproduction unit 126, it is assumed that, by using the updating unit 125, a packet having “seeds” at predetermined intervals is accumulated as data on the decoding side. When this part is called, a packet having the nearest “seed” is searched (step S2201). More specifically, when a packet number at which jump reproduction is started is set as seq_{—}1, seq_{—}0 which satisfies the following condition corresponds to the packet:

seq_{—}0=max {seq|seq≦seq_{—}1, there is a seed corresponding to seq}.

A pseudo random number bit string is generated by using the “seed” as an initial vector (step S2202). By using the seq of the packet as an initial value seq_{—}0, seq_{—}0 is subtracted from seq given to the packet before decoding is performed to correct the seq.

The reason why the packet number seq is necessary on the decoding side will be described below. Since a pseudo random number bit string is updated by using seq, when the seq received from the coding side is not changed, the pseudo random number bit string is updated. In order to prevent this, when jump reproduction is performed to regenerate the pseudo random number bit string, counting is performed from seq=0 again. Therefore, the packet number at which jump reproduction is started is set as seq_{—}0, and the packet number seq transmitted from the coding side is uniformly corrected by minus seq_{—}0. When the correction is not performed, as indicated by reference numeral 2203, a bit string having a length equal to that of the bit string formed by the coding unit may have to be generated.

(Stepping-Stone Decoding Unit 127)

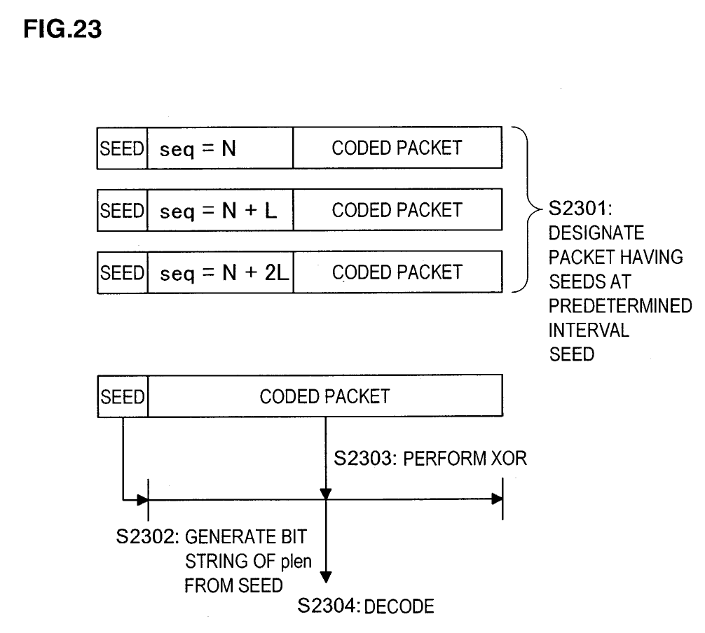

FIG. 23 is a diagram for explaining the function of the stepping-stone decoding unit 127.

The stepping-stone decoding unit 127 does not assume that the stepping-stone decoding unit 127 is used when double speed reproduction with a moderate increase/decrease of seq is performed. In such a case, when a pseudo random number bit string is generated by a normal method, a high-speed operation can be achieved. In this case, it is assumed that coded packets are sent in such a jump state that the packets are jumped like stepping stones every three seconds and must be decoded. More specifically, this case is a case in which even though a “seed” is sent, pseudo random number bit strings can be generated at a speed higher than a speed at which pseudo random number bit strings are generated one by one. Even in this case, it is assumed that packets having “seeds” at predetermined intervals are accumulated on the coding side as data by using the seed extraction unit. The stepping-stone decoding unit 127 sequentially decodes the packets having the “seeds”.

As processes of the stepping-stone decoding unit 127, packets having “seeds” are designated at predetermined intervals (step S2301), and a pseudo random number bit string a packet length is generated by using the “seeds” as initial vectors (step S2302). XOR between the generated pseudo random number bit string and a packet is performed (step S2303), and the packet is decoded (step S2304). These processes are continued while a fast feeding/rewinding operation continues. When reproduction is restarted, the jump reproduction unit 126 may be called.

(Operation of Fifth Embodiment)

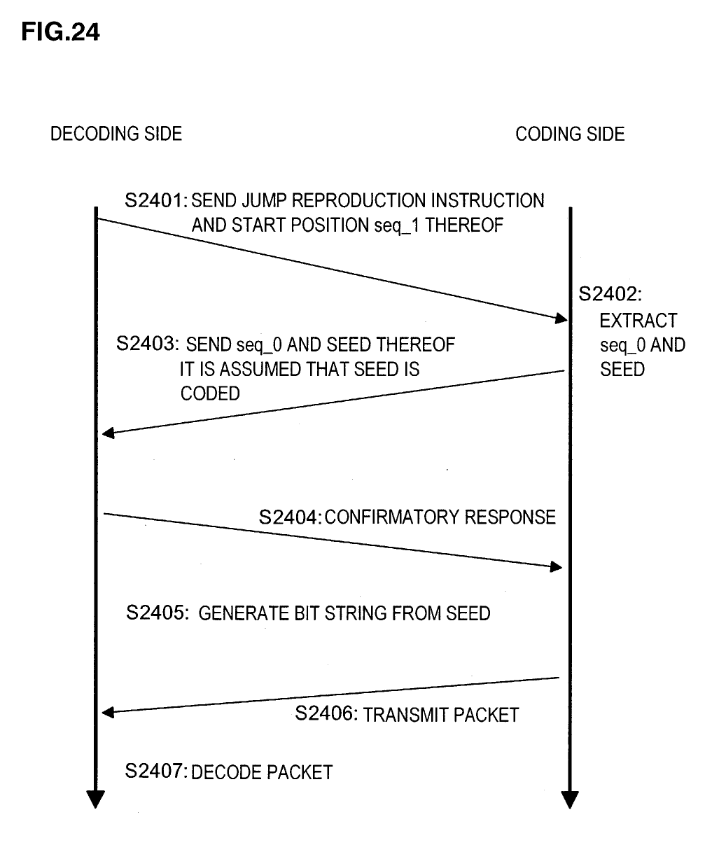

FIG. 24 is a diagram for explaining a flow of transmission/reception of the stepping-stone decoding unit 127.

It is assumed that a set of a packet and a seed is stored as data on a coding side. This operation includes the following procedures:

1. A decoding side (reception side) transmits instruction of jump reproduction and a packet number seq_{—}1 for designating a position where reproduction is started to a coding side (transmission side) (step S2401).

2. The coding side selects a packet which has a seed and which is closest to the packet at which reproduction is started (step S2402). More specifically, the packet corresponds to seq_{—}0 which satisfies the following condition:

seq_{—}0=max {seq|seq≦seq_{—}1, there is a seed corresponding to seq}.

3. A packet number seq_{—}0 is transmitted to a decoding side (reception side) (step S2403). In transmission and reception, a public key code or a key used for coding a packet is used.

4. A decoding side transmits a confirmatory response (step S2404) and generates a pseudo random number bit string having a normal length (maxplen×4) by using a seed as an initial vector (step S2405).

5. seq held by a packet is corrected by subtracting seq_{—}0.

6. XOR between a packet and a pseudo random number bit string is performed. The subsequent procedures are the same as those in the third embodiment (step S2406 which transmits a packet and step S2407 which decodes a packet).

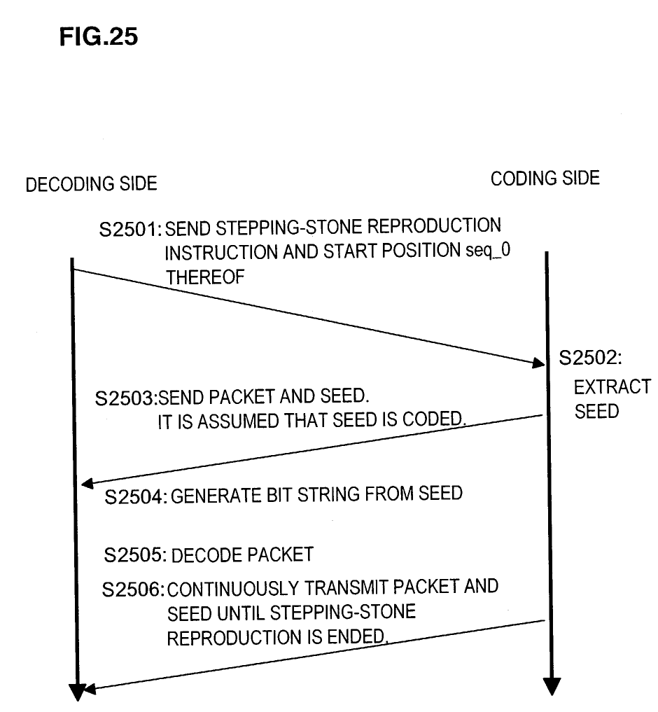

FIG. 25 is a diagram for explaining a flow of transmission/reception in stepping-stone reproduction.

In this case, it is assumed that a set of a packet and a seed is stored on a coding side as data in advance.

1. A decoding side (reception side) transmits an instruction of stepping-stone reproduction (fast feeding or rewinding operation) to a coding side (transmission side) (step S2501).

2. The coding side extracts seeds from packets having seeds at predetermined intervals (step S2502) and transmits the seeds to the decoding side (step S2503). The predetermined interval is determined depending on intervals at which a fast feeding/rewinding operation is performed. The seeds are coded and then transmitted.

3. The decoding side generates a pseudo random number bit string having a length equal to a packet length by using a seed as an initial vector (step S2504).

4. XOR between a packet and a pseudo random number bit string is performed (step S2505).

5. Packets and seeds are continuously transmitted until the stepping-stone reproduction is ended (step S2506). When normal reproduction is restarted, the jump reproduction unit 126 is called.

(Effect of Fifth Embodiment)

When a “seed” is given to a coded packet on a database, all places on a pseudo random number bit string can be quickly accessed. This is a necessary function when movie delivery with special reproduction as follows:

jump reproduction

fast feeding

rewinding

(Sixth Embodiment)

In this embodiment, a function of extending a pseudo random number bit string is added. This function, in the third embodiment, is effective when a packet larger than a packet expected at first, i.e., a packet having a length which satisfies plen>maxplen is processed.

The reason why the function is effective is as follows. That is, although an updating decision of a bit string is performed when a packet number seq is a certain value or more, i.e., on the basis of the following expression:

seq×4>maxplen×(secnumber+1),

this decision condition depends on that the packet length plen is smaller than maxplen. If not, a pseudo random number bit string which has not been updated when a packet is coded may be used. Therefore, when a packet which is larger than an expected packet must be processed, a pseudo random number bit string on packaging itself must be extended. As in the first and second embodiments, when a pseudo random number bit string having a predetermined length must be continuously used, the pseudo random number bit string need not be extended. A packet is folded, so that a pseudo random number bit string generated at first may be repeatedly used.

(Sixth Embodiment)

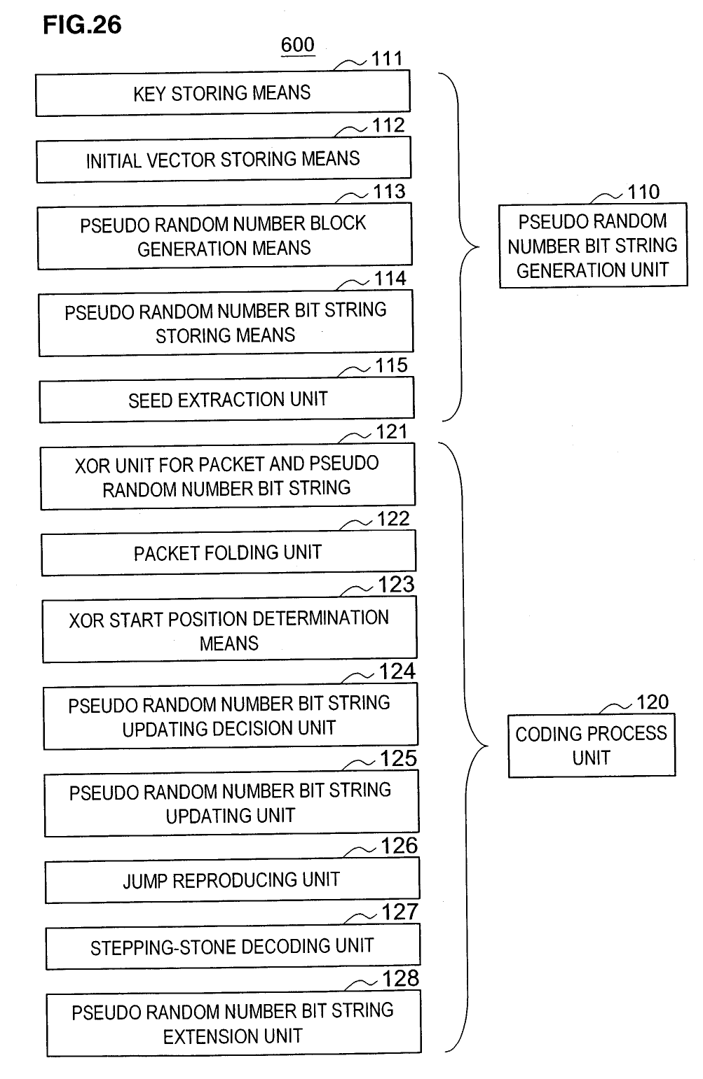

FIG. 26 is a diagram for explaining the configuration of a coding process device 600 according to this embodiment. A coding process device 300, as shown in FIG. 26, comprises two constituent elements, i.e., a pseudo random number bit string generation unit 110 and a coding process unit 120. Since the configuration of the pseudo random number bit string generation unit 110 is substantially the same as that in the fifth embodiment, an overlapping description will be omitted. The coding process unit 120 is obtained by adding a pseudo random number bit string extension unit 128 to the configuration of the fifth embodiment.

It can be considered that an original pseudo random number bit string is extended from the end. However, in the third embodiment, a pseudo random number bit string on packaging must be updated. Several devises are necessary such that the pseudo random number bit string is correctly updated to use the same pseudo random number bit string in both the coding and decoding processes. In the third embodiment, a method of updating a pseudo random number bit string is that “pseudo random number bit string on packaging is updated ¼ by ¼”. The decision method is that “when a packet number seq satisfies a condition:

seq×4>maxplen×(secnumber+1),

the contents of I_sec (secnumber mode 4) are updated from T_sec (secnumber) into T_sec (secnumber+4)”.

Since the condition:

seq×4>maxplen×(secnumber+1)

is used, secnumber must be taken again by an increase in maxplen.

In the third embodiment, since secnumber describes a specific sec in which the (maxplen×4)th byte from the start of the theoretical pseudo random number bit string is set, secnumber may be taken again to satisfy the following expression:

(maxseq×4)/maxplen−1<secnumber≦(maxseq×4)/maxplen.

where

secnumber: section number to be updated next

maxseq: the maximum value of packet numbers seq which have been taken by now

maxplen: new maxplen which serves as a unit of one section.

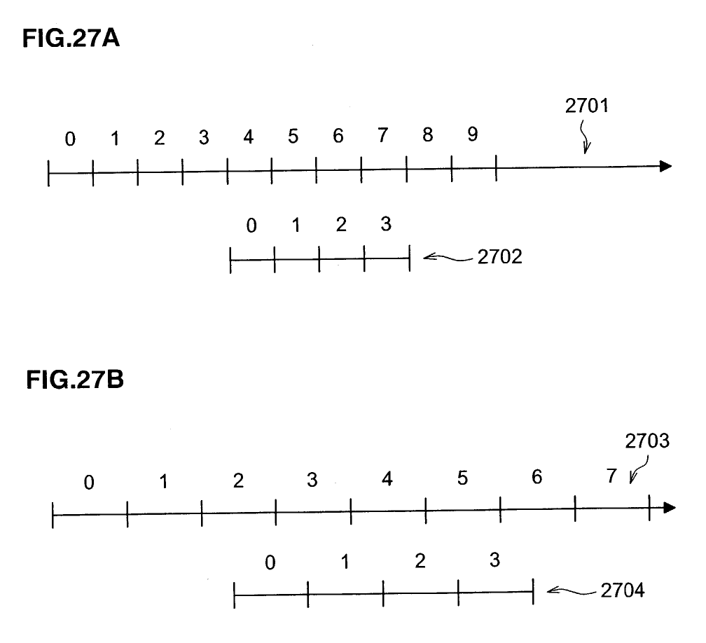

An updating method will be described next. In the third embodiment, the contents of I_sec (secnumber mod 4) are updated from T_sec (secnumber) into T_sec (secnumber+4). However, as shown in FIGS. 27A and 27B, the following two drawbacks are posed.

FIGS. 27A and 27B are diagrams for explaining drawbacks in extension of a pseudo random number bit string. FIG. 27A shows sectioning of theoretical pseudo random number bit strings before extension of maxplen. Reference numeral 2701 denotes a theoretical pseudo random number bit string, and reference numeral 2702 denotes a pseudo random number bit string on packaging. FIG. 27B shows sectioning of the theoretical pseudo random number bit string after extension of maxplen. Reference numeral 2703 denotes a theoretical pseudo random number bit string, and reference numeral 2704 denotes a pseudo random number bit string on packaging. Before extension of maxplen, as shown in FIG. 27A, the pseudo random number bit string 2702 on packaging, secnumber corresponds the contents of each section of the theoretical pseudo random number bit string 2701.

On the other hand, after extension of maxplen, as shown in FIG. 27B, the following two drawbacks are posed.

The start of the pseudo random number bit string 2704 on packaging does not reach a boundary between sections of the theoretical pseudo random number bit string 2703. More specifically, although the pseudo random number bit string must be updated section by section, the pseudo random number bit string is not updated section by section.

Even though the start of the pseudo random number bit string 2704 on packaging reaches a boundary between sections of the theoretical pseudo random number bit string 2703, the contents to be updated of I_sec (secnumber mod 4) are not always T_sec (secnumber).

In the following embodiment, the following solving methods are employed.

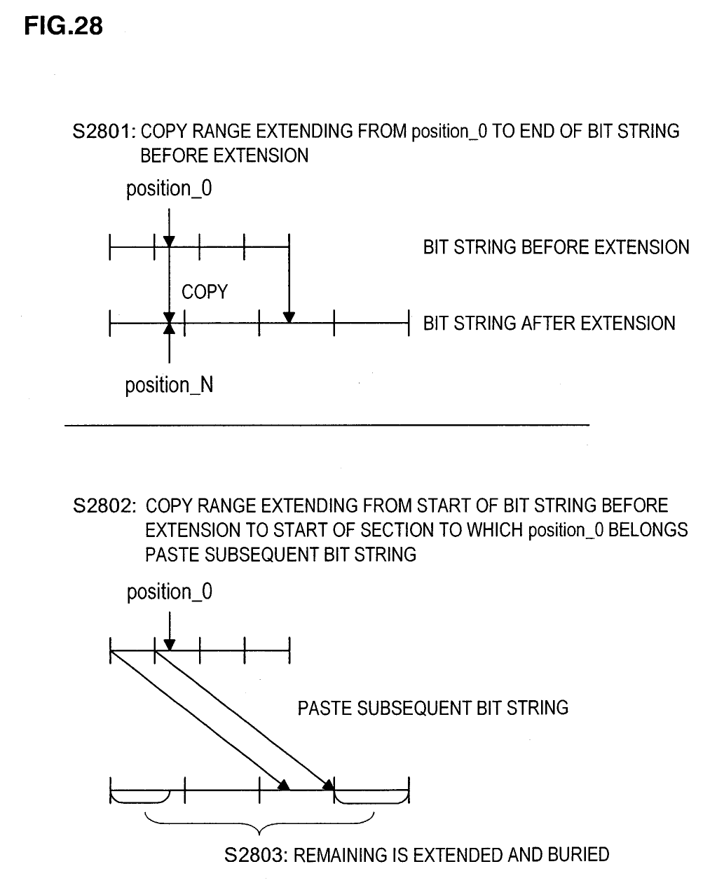

FIG. 28 is a diagram for explaining a method of extending a pseudo random number bit string on packaging according to this embodiment. “_{—}0” is added to a value obtained before the extension, and “_N” is added to a value obtained after the extension. For example, the length of the pseudo random number bit string on packaging obtained after the extension is expressed by streamlength_N.

1. A region having a length of maxplen_N×4 is secured. A pseudo random number bit string is stored in this region and used as a new pseudo random number bit string.

2. On the pseudo random number bit string before the extension, a part extending from position_{—}0 to the end of the pseudo random number bit string is copied (step S2801).

3. On the pseudo random number bit string after the extension, the part copied in item 2. is pasted from position_N. When the part runs out, the part is looped.

4. On the pseudo random number bit string before the extension, a part extending from the start to the start of a section to which position belongs is copied (the inside of the section is not included) (step S2802).

5. On the pseudo random number bit string after the extension, the part copied in item 4. is pasted subsequently to the end of the paste in item 3.

6. A part which has not been buried in the pseudo random number bit string after the extension is extended and buried (step S2803).

(Operation of Sixth Embodiment)

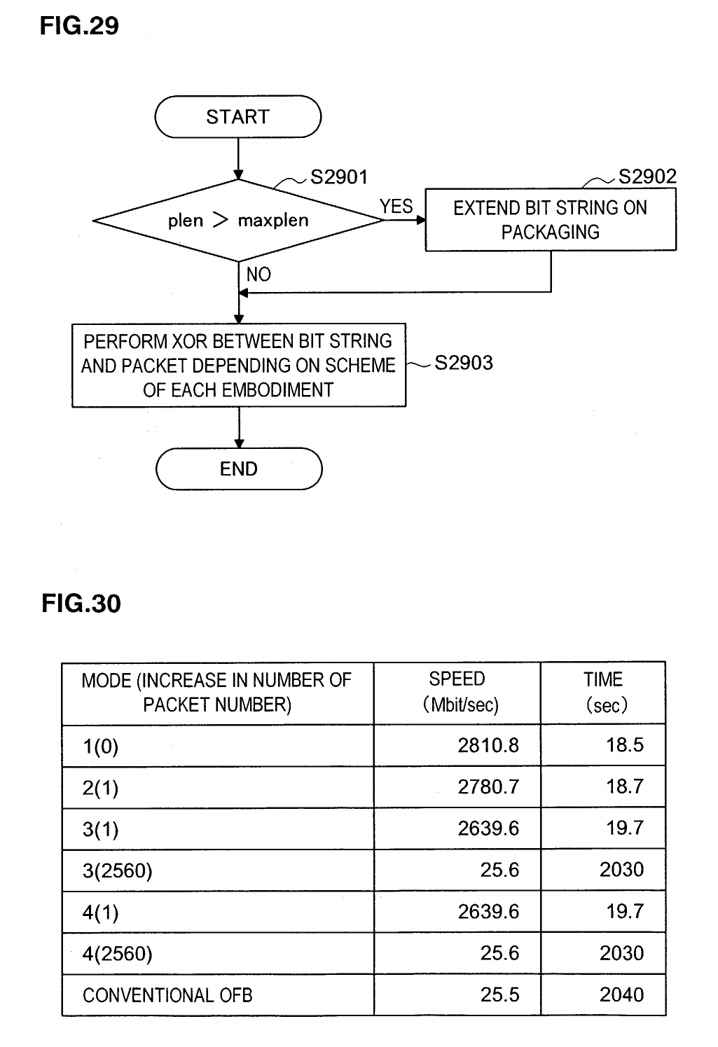

FIG. 29 is a diagram for explaining an operation of the sixth embodiment.

The length plen of a packet to be processed is compared with maxplen in size (step S2901). When plen>maxplen is satisfied, the pseudo random number bit string on packaging is extended by the method described in FIG. 28 (step S2902). When plen≦maxplen is satisfied, the pseudo random number bit string on packaging is not extended. Thereafter, a coding/decoding operation is performed by the method described in the third embodiment (step S2903).

(Effect of Sixth Embodiment)

In live delivery, the length of a packet to be process always varies depending on various factors such as the state of a network, an image to be reproduced, and an operation by an operator or a user. In this state, prediction of the length of a packet, i.e., prediction of the maximum value maxplen of the length of a packet is difficult. Although the length of the packet changes, it is inconvenient that a user performs an operation for the change of the length point by point. Therefore, a module must automatically cope with the change of the length of the packet. According to this embodiment, such a problem can be solved.

FIG. 30 is a diagram for explaining results of speed tests of the respective embodiments.

In each test, a method for processing a packet of 10 Kbytes and looping the process 665600 times to measure time is employed. As a coding function, Rijndael is used. As a packet number, a packet number which is incremented one by one and a packet number which is incremented 2560 by 2560 (Since 10 kbyte=10240 byte, ¼ of 10240. That is, the start position of XOR is shifted by a packet length) are considered.

In “conventional OFB”, a 16-byte buffer is taken, and the following procedures are performed.

(1) An initial vector is substituted for a buffer.

(2) The buffer is rewritten by a coding function.

(3) XOR between a packet and a buffer is performed by 16 bytes.

Procedures (2) and (3) are continuously performed to all packets until XOR is performed.

Since one CD-R has a capacity of 650 MB=665600 kB, this method is also an experiment for measuring a minimum time required for coding 10 CD-Rs (However, in only conventional OFB, a value which is 100 times time required for performing looping 6656 times is employed.). In addition, the specifications of a computer used in the test are as follows:

CPU: Pentium IV (registered mark), 1.3 GHz

OS: Windows 2000 (registered mark)

HDD: 50 GB

memory: 128 MB.

The results are as shown in FIG. 30. According to this table, two things are obtained.

1. When an increase in packet number is set to be 1, a speed which is approximately 100 times a speed obtained when an increase in packet number is set to be a packet length (for example, (1) and (2560) in mode 4). For this reason, a high-speed operation can be achieved by the demand standard of security.

2. A speed in the “ordinary OFB” is rarely different from a speed obtained when an increase in packet number is set to be a packet length in mode 4. For this reason, it is understood that high stability can be obtained while keeping the speed high.

The preferred embodiments of a coding process method and a coding process device according to the present invention have been described above with reference to the accompanying drawings. However, the present invention is not limited to the embodiments. It is apparent that a person skilled in the art can conceive various changes and modifications without departing from the spirit and scope of the invention. It is understood that these changes and modifications belong to the spirit and scope of the invention as a matter of course.

As has been described above, the main effects of the present invention are as follows:

1. A pseudo random number bit string is generated in advance, and, according to an arbitrary packet number added to a packet, a specific region of the pseudo random number bit string to be used is unified. For this reason, a reception side can decode packets regardless of a packet loss.

2. When an increase in packet number is set to be low, a pseudo random number bit string is not used only once every packet and is repeatedly used to make it possible to achieve a high-speed operation.

3. When a pseudo random number bit string which is sufficiently long is used, a coding/decoding operation can be performed even if a packet number does not monotonously increase. In this manner, the device can cope with disturbance of the order of packets in communication.

4. When a coding side (transmission side) stores a coded packet, a packet number, and a seed of a packet, an arbitrary packet can be decoded without generating a pseudo random number bit string at first. In this manner, special reproduction such as jump reproduction, a fast feeding or rewinding operation can be performed.

5. Since a pseudo random number bit string on packaging can be extended, a packet having a packet length which is larger than a packet length expected at first can be processed. In an environment such as an environment for live delivery including many unstable elements, the length of a packet to be processed need not be predicted in advance. The device can quickly cope with a packet length even if the packet length radically changes.

What is claimed is:

1. A coding process method for performing a coding process of stream data transmitted in units of packets, comprising:
the first step of predicting the maximum length of a bit string (in-packet bit string) included in each of the packets to generate a pseudo random number bit string having a length larger than the predicted maximum length of the in-packet bit string; and
the second step of performing a coding process of the in-packet bit string by using the pseudo random number bit string.

2. A coding process method according to claim 1, wherein when the length of the in-packet bit string is larger than the length of the pseudo random number bit string in the second step,
the bit sting in the packet is divided by the length of the pseudo random number bit string, a coding process is sequentially performed to the divided bit strings by using the pseudo random number bit string, and the coding process is repeated until the length of the bit string (unprocessed bit string) in the packet which is not subjected to the coding process is not larger than the length of the pseudo random number bit string, and
the unprocessed bit string is subjected to a coding process by using a bit string corresponding to the length of the unprocessed bit string from the start of the pseudo random number bit string.

3. A coding process method according to claim 1, wherein, in the second step, a start position of the pseudo random number bit string at which a coding process of the in-packet bit string each time a coding process of a predetermined number of packets.

4. A coding process method according to claim 3, wherein, in the second step, when the length of the in-packet bit string is larger than a length extending from the start position of the pseudo random number bit string to an end position,
by using a bit string extending from the start position of the pseudo random number bit string to the end position, a coding process of a part of the bit in the packet is performed, and a coding process of the in-packet bit string (unprocessed bit string) which has not been subjected to the coding process by using a bit string corresponding to the length of the unprocessed bit string from the start of the pseudo random number bit string.

5. A coding process method according to claim 1, wherein, in the second step, at least a part of the pseudo random number bit string is updated each time a coding process of a predetermined number of packets is performed.

6. A coding process method according to claim 1, wherein the length of the pseudo random number bit string is at least 3 times or more of the maximum length of the in-packet bit string.

7. A coding process method according to claim 1, wherein seed data for generating a pseudo random number bit string corresponding to a number added to the packet is stored every predetermined number of packets.

8. A coding process method according to claim 1, wherein, in the second step, when the length of the in-packet bit string is larger than the length of the pseudo random number bit string,
the pseudo random number bit string is extended.

9. A coding process device for performing a coding process of stream data transmitted in units of packets, comprising:
a pseudo random number bit string generation unit for predicting the maximum length of a bit string (in-packet bit string) included in each of the packets to generate a pseudo random number bit string having a length larger than the predicted maximum length of the in-packet bit string; and
a coding process unit for performing a coding process of the in-packet bit string by using the pseudo random number bit string.

10. A coding process device according to claim 9, wherein the coding process unit comprises
an in-packet bit string division unit for dividing the in-packet bit string by the length of the pseudo random number bit string.

11. A coding process device according to claim 9, wherein the coding process unit further comprises a start position determination unit for determining a start position of the pseudo random number bit string at which the coding process of the in-packet bit string is performed.

12. A coding process device according to claim 9, wherein the coding process unit further comprises
an updating decision unit for deciding whether updating of the pseudo random number bit string is necessary or not and an updating unit for updating at least a part of the pseudo random number bit string.

13. A coding process device according to claim 9, wherein the pseudo random number bit string generation unit further comprising:
a seed extraction unit for holding seed data for generating a pseudo random number bit string corresponding to a number added to the packet to each of a predetermined number of packets, and
the coding process unit further comprises a jump reproduction unit for selecting a packet for holding the seed data closest to a predetermined packet and generating the pseudo random number bit string by using the seed data held by the packet.

14. A coding process device according to claim 13, wherein the coding process unit further comprises
a stepping-stone decoding unit for sequentially generating the pseudo random number bit strings by using seed data held by packets arranged at predetermined intervals.

15. A coding process device according to claim 9, wherein the coding process unit further comprises
an extension unit for extending the pseudo random number bit string.
